(19) United States
(12) Patent Application Publication
(10) Pub. No.: US 2026/0253954 A1
(43) Pub. Date: Aug. 27, 2026

(54) ELECTROLYTE, ELECTROCHEMICAL DEVICE USING SAME, AND ELECTRONIC DEVICE

(71) Applicant: Ningde Amperex Technology Limited, Ningde (CN)

(72) Inventors: Hui CUI, Ningde (CN); Chao TANG, Ningde (CN)

(73) Assignee: Ningde Amperex Technology Limited, Ningde (CN)

(21) Appl. No.: 19/631,099

(22) Filed: Mar. 27, 2026

Related U.S. Application Data
(63) Continuation of application No. PCT/CN2024/122158, filed on Sep. 29, 2024.

(30) Foreign Application Priority Data
Sep. 28, 2023 (CN) 202311279437.9

(51) Int. Cl. H01M 10/0567; H01M 10/0568

(52) U.S. Cl. CPC H01M 10/0567; H01M 10/0568

(57) ABSTRACT

An electrolyte comprises a fluorine-containing cyclic carbonate represented by formula I

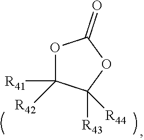

a first compound and a second compound, the first compound comprising at least one of a compound of formula II

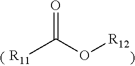

and a compound of formula III

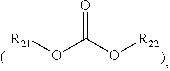

and the second compound comprising at least one of a compound of formula IV

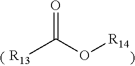

and a compound of formula V

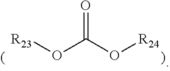

### CROSS REFERENCE TO THE RELATED APPLICATIONS

This application is a continuation under 35 U.S.C. § 120 of international patent application PCT/CN2024/122158 filed on Sep. 29, 2024, which claims priority to the Chinese Patent Application No. 202311279437.9 filed with the China Patent Office on Sep. 28, 2023 and entitled “ELECTROLYTE, ELECTROCHEMICAL DEVICE USING SAME, AND ELECTRONIC DEVICE”, which is incorporated herein by reference in its entirety.

### TECHNICAL FIELD

This application relates to the field of energy storage technology, and in particular, to an electrolyte, an electrochemical device using the same, and an electronic device.

### BACKGROUND

Lithium-ion batteries, due to their high energy density, good cycle performance, safety, environmental friendliness, and zero memory effect, are widely used in portable electronic products, electric vehicles, aerospace, and energy storage applications. To meet the demands of societal development, the pursuit of electrochemical devices with higher energy and power density has become an urgent issue. This has driven the development of positive electrode active materials toward high voltages. As voltage increases, the reaction of the electrolyte at the positive electrode interface intensifies, leading to rapid performance degradation, particularly in low-temperature discharge performance and high-rate discharge performance.

Therefore, there is a need to provide an electrolyte capable of improving the low-temperature discharge performance and high-rate discharge performance of electrochemical devices.

### SUMMARY

Some embodiments of this application provide an electrolyte, attempting to address at least one problem existing in the related art to at least some extent. The embodiments of this application also provide an electrochemical device using such electrolyte and an electronic device.

In one embodiment, this application provides an electrolyte, where the electrolyte includes:
(1) a fluorinated cyclic carbonate represented by formula I:

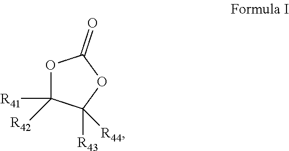

where R₄₁, R₄₂, R₄₃, and R₄₄ are each independently F or a substituted or unsubstituted C₁-C₃ alkyl; when substituted, substituents are each independently a halogen; where at least one of R₄₁, R₄₂, R₄₃, or R₄₄ contains F;
(2) a first compound, where the first compound includes at least one selected from the group consisting of a compound of formula II and a compound of formula III:

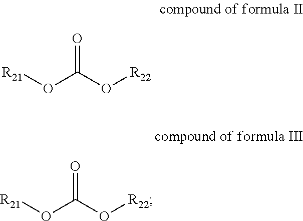

where R₁₁, R₁₂, R₂₁, and R₂₂ are each independently a C₁-C₁₀ alkyl; and
(3) a second compound, where the second compound includes at least one selected from the group consisting of a compound of formula IV and a compound of formula V:

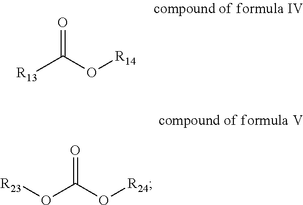

where:
R₁₃ and R₁₄ are each independently a substituted or unsubstituted C₁-C₁₀ alkyl, where at least one of R₁₃ or R₁₄ is substituted;
R₂₃ and R₂₄ are each independently a substituted or unsubstituted C₁-C₁₀ alkyl, where at least one of R₂₃ or R₂₄ is substituted;
when substituted, substituents are each independently a halogen; and
based on a mass of the electrolyte, a mass percentage of the first compound is A %, a mass percentage of the fluorinated cyclic carbonate is B %, and a mass percentage of the second compound is C %, where 30≤(A+B+C)≤90 and 20≤C≤61.

In some embodiments, 50≤(A+B+C)≤87.5.

In some embodiments, 4≤B≤15.

In some embodiments, 2.8≤(A+C)/B≤12.

In some embodiments, the electrolyte further includes a fluoroether compound represented by formula VI:

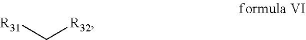

where R₃₁ and R₃₂ are each independently selected from the group consisting of a substituted or unsubstituted C₁-C₈ alkyl and —R′—O—R″;
R′ is selected from a substituted or unsubstituted C₁-C₈ alkylene;
R″ is selected from a substituted or unsubstituted C₁-C₈ alkyl;
when substituted, substituents are each independently a halogen;
at least one of R₃₁ or R₃₂ contains F; and
based on the mass of the electrolyte, a mass percentage of the fluoroether compound is D %, where 5≤D≤30.

In some embodiments, 50≤(A+B+C+D)≤87.5.

In some embodiments, 60≤(A+B+C+D)≤80.

In some embodiments, the compound of formula II includes at least one selected from the group consisting of the following compounds: methyl formate, ethyl formate, methyl acetate, ethyl acetate, propyl acetate, methyl propionate, ethyl propionate, and propyl propionate; and/or
the compound of formula III includes at least one selected from the group consisting of the following compounds: dimethyl carbonate, diethyl carbonate, and ethyl methyl carbonate.

In some embodiments, the fluorinated cyclic carbonate includes at least one selected from the group consisting of the following compounds:

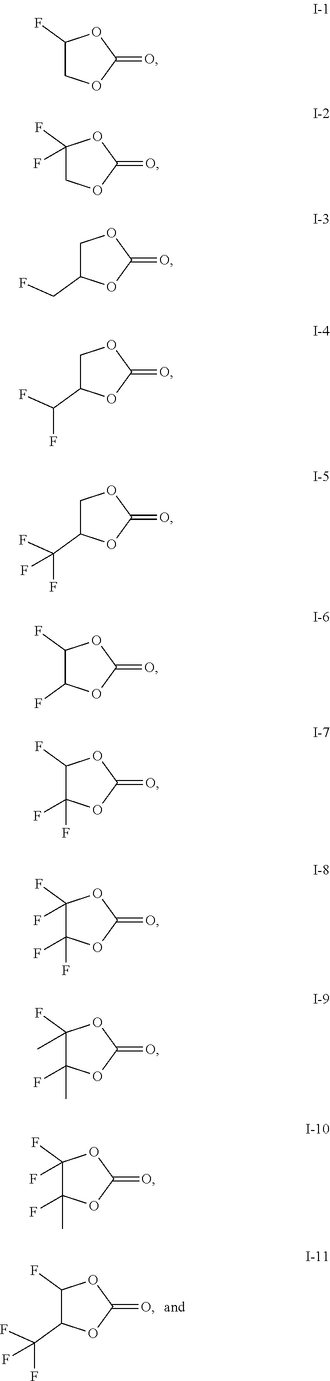

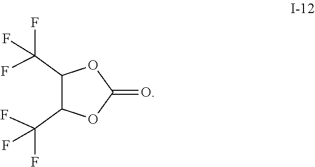 [SMILES: O=C1OC(C(F)(F)F)C(C(F)(F)F)O1]

In some embodiments, the compound of formula IV includes at least one selected from the group consisting of the following compounds:

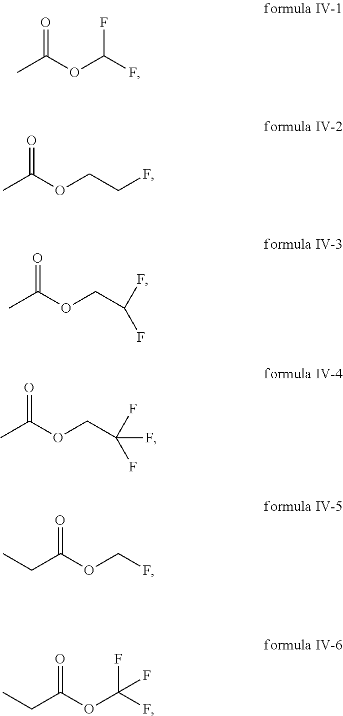

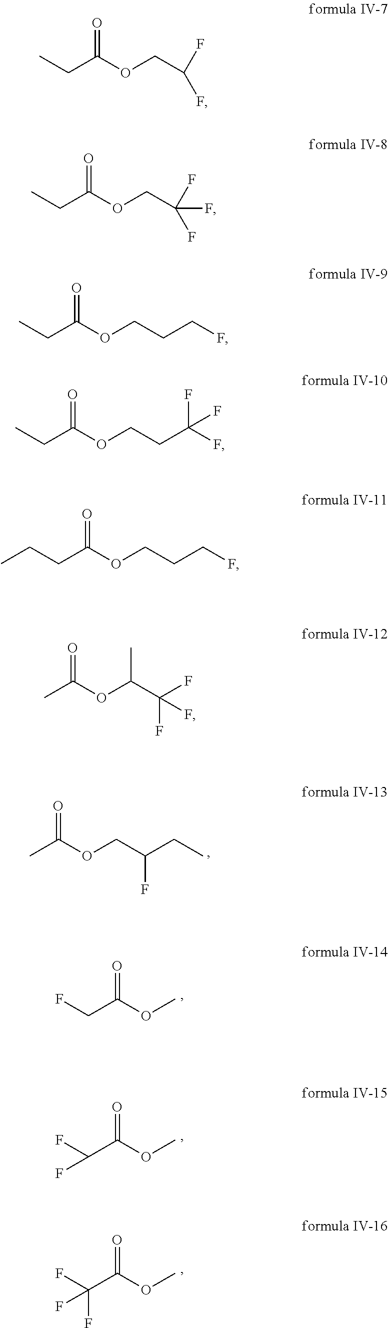

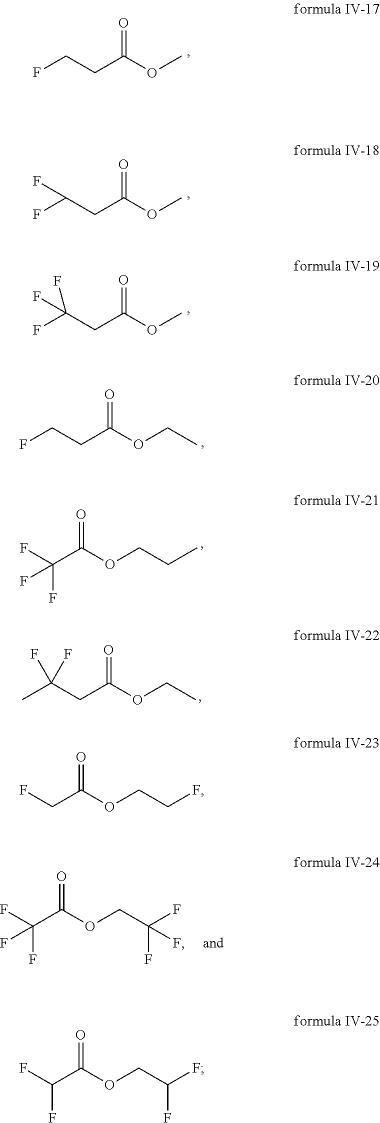

and/or
the compound of formula V includes at least one selected from the group consisting of the following compounds:

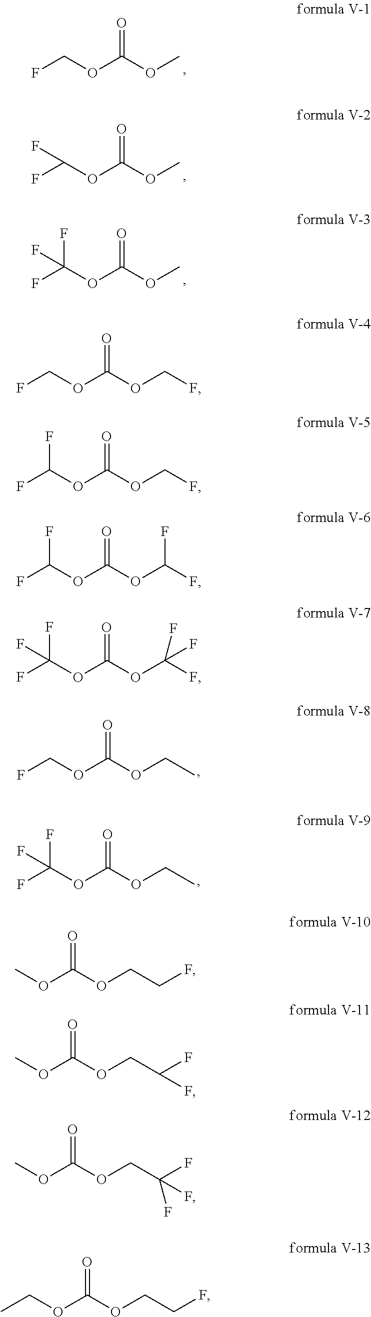

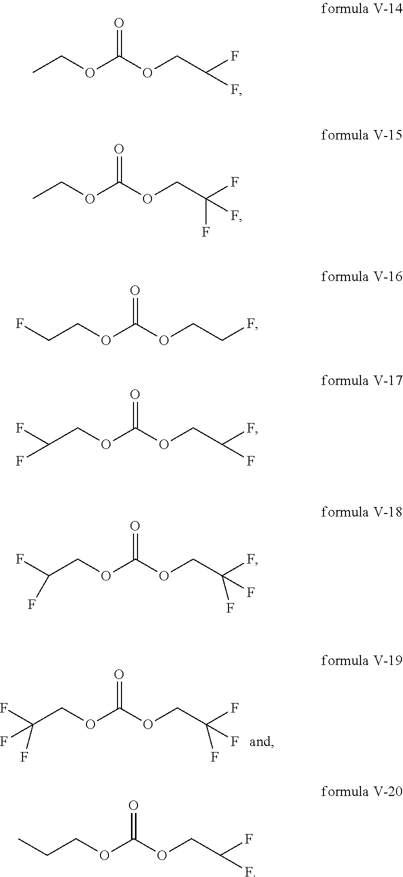

In some embodiments, the fluoroether compound includes at least one selected from the group consisting of the following compounds:

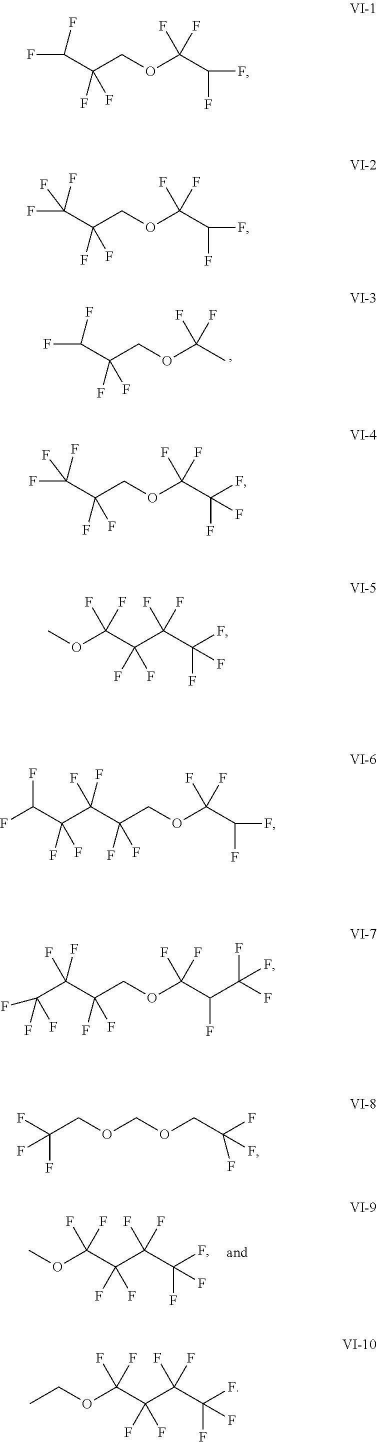

In some embodiments, the electrolyte further includes a first lithium salt, where the first lithium salt contains at least one selected from the group consisting of lithium hexafluorophosphate LiPF₆ and lithium bis(fluorosulfonyl)imide LiFSI; and based on the mass of the electrolyte, a mass percentage of the first lithium salt is E %, where 2.5≤(A+B+C)/E≤8.5.

In some embodiments, the electrolyte further includes a second lithium salt, where the second lithium salt includes at least one selected from the group consisting of the following: lithium bis(trifluoromethanesulfonyl)imide LiTFSI, lithium tetrafluoroborate LiBF₄, lithium difluoro (oxalato) borate LiDFOB, lithium bis(oxalato) borate LiBOB, and lithium difluorophosphate LiPO₂F₂; where based on the mass of the electrolyte, a mass percentage of the second lithium salt is 0.1% to 5%.

In some embodiments, the electrolyte further includes a third compound, where the third compound includes at least one selected from the group consisting of the following compounds: vinylene carbonate, 1,3-propane sultone, succinonitrile, adiponitrile, and 1,3,6-hexanetricarbonitrile.

In some embodiments, based on the mass of the electrolyte, a mass percentage of the third compound is 0.5% to 6%.

In another embodiment, this application provides an electrochemical device including: a positive electrode, a negative electrode, a separator, and the electrolyte according to some embodiments of this application.

In another embodiment, this application provides an electronic device including the electrochemical device according to some embodiments of this application.

The electrochemical device provided in some embodiments of this application exhibits improved low-temperature discharge performance and high-rate discharge performance. The reason may be that the first compound, the second compound, and the fluorinated cyclic carbonate represented by formula I have relatively low binding energy with lithium ions, making it easier for lithium ions to dissociate from the solvent at low temperatures and high rates, thereby improving the discharge performance of the electrochemical device. When the mass percentage A % of the first compound, the mass percentage B % of the fluorinated cyclic carbonate represented by formula I, and the mass percentage C % of the second compound, where 30≤(A+B+C)≤90 and 20≤C≤61, the low-temperature discharge performance and high-rate discharge performance of the electrochemical device can be significantly improved. When the electrolyte further contains a fluoroether compound, a lithium salt additive, and/or the third compound, the low-temperature discharge performance and high-rate discharge performance of the electrochemical device can be further improved.

Additional aspects and advantages of some embodiments of this application are partially described, shown, or explained through the implementation of the embodiments of this application in the following description.

### DESCRIPTION OF DRAWINGS

The drawings necessary for describing the embodiments of this application or the prior art will be briefly described below to facilitate the description of the embodiments of this application. It is apparent that the drawings described below represent only some embodiments of this application. For those skilled in the art, other drawings of embodiments can be obtained based on the structures illustrated in these drawings without creative effort.

FIG. 1 is a schematic structural diagram of a lithium-ion battery of this application.

### DETAILED DESCRIPTION

The embodiments of this application are described in detail below. The embodiments of this application should not be construed as limiting this application.

In this document, quantities, ratios, and other numerical values are presented in a range format. It should be understood that such range formats are used for convenience and brevity and should be interpreted flexibly, encompassing not only the values explicitly specified as range limits but also all individual values or sub-ranges within the specified range, as if each value and sub-range were explicitly specified.

In the detailed description and claims, a list of items connected by the terms “one of”, “one”, “a kind of”, or other similar terms may mean any one of the listed items. For example, if items A and B are listed, the phrase “one of A and B” means only A or only B. In another example, if items A, B, and C are listed, the phrase “one of A, B, and C” means only A, only B, or only C. Item A may include a single element or multiple elements. Item B may include a single element or multiple elements. Item C may include a single element or multiple elements.

In the detailed description and claims, a list of items connected by the terms “at least one of”, “at least one”, “at least a kind of”, or other similar terms may mean any combination of the listed items. For example, if items A and B are listed, the phrase “at least one of A and B” means only A; only B; or A and B. In another example, if items A, B, and C are listed, the phrase “at least one of A, B, and C” means only A; only B; only C; A and B (excluding C); A and C (excluding B); B and C (excluding A); or all of A, B, and C. Item A may include a single element or multiple elements. Item B may include a single element or multiple elements. Item C may include a single element or multiple elements.

As used herein, the term “alkyl” is expected to be a straight-chain saturated hydrocarbon structure having 1 to 20 carbon atoms. “Alkyl” is also expected to be a branched or cyclic hydrocarbon structure having 3 to 20 carbon atoms. When an alkyl with a specific carbon number is specified, it is expected to encompass all geometric isomers with that carbon number. Therefore, for example, “butyl” includes n-butyl, sec-butyl, isobutyl, tert-butyl, and cyclobutyl; “propyl” includes n-propyl, isopropyl, and cyclopropyl. Examples of alkyl groups include, but are not limited to, methyl, ethyl, n-propyl, isopropyl, cyclopropyl, n-butyl, isobutyl, sec-butyl, tert-butyl, cyclobutyl, n-pentyl, isopentyl, neopentyl, cyclopentyl, methylcyclopentyl, ethylcyclopentyl, n-hexyl, isohexyl, cyclohexyl, n-heptyl, octyl, cyclopropyl, cyclobutyl, norbornyl, and the like.

As used herein, the term “halogen” may be F, Cl, Br, or I.

### 1. Electrolyte

This application provides an electrolyte, where the electrolyte includes:
(1) a fluorinated cyclic carbonate represented by formula I:

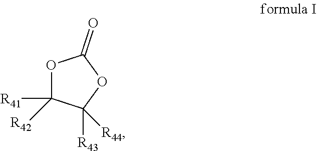

where R₄₁, R₄₂, R₄₃, and R₄₄ are each independently F or a substituted or unsubstituted C₁-C₃ alkyl; when substituted, substituents are each independently a halogen; where at least one of R₄₁, R₄₂, R₄₃, or R₄₄ contains F;
(2) a first compound, where the first compound includes at least one selected from the groun consisting of a compound of formula II and a compound of formula III:

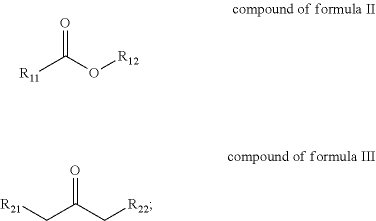

where R₁₁, R₁₂, R₂₁, and R₂₂ are each independently a C₁-C₁₀ alkyl; and
(3) a second compound, where the second compound includes at least one selected from the group consisting of a compound of formula IV and a compound of formula V:

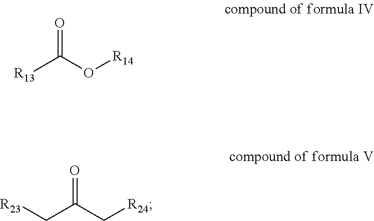

where:
R₁₃ and R₁₄ are each independently a substituted or unsubstituted C₁-C₁₀ alkyl, where at least one of R₁₃ or R₁₄ is substituted;
R₂₃ and R₂₄ are each independently a substituted or unsubstituted C₁-C₁₀ alkyl, where at least one of R₂₃ or R₂₄ is substituted;
when substituted, substituents are each independently a halogen; and
based on a mass of the electrolyte, a mass percentage of the first compound is A %, a mass percentage of the fluorinated cyclic carbonate is B %, and a mass percentage of the second compound is C %, where 30≤(A+B+C)≤90 and 20≤C≤61.

In some embodiments, C is 20, 25, 30, 32, 35, 40, 45, 50, 52, 55, 60, 61, or in a range of any two of these values.

The inventors have found that the use of a combination of the fluorinated cyclic carbonate represented by formula I, the first compound, and the second compound in the electrolyte, with total content of the three controlled, can significantly improve the low-temperature discharge performance and high-rate discharge performance of the electrochemical device. Without being bound by any theory, this may be because the above three compounds have relatively low binding energy with lithium ions, making it easier for lithium ions to dissociate from the solvent at low temperatures and high rates, thereby improving the discharge performance of the electrochemical device. When the sum of the mass percentage A % of the first compound, the mass percentage B % of the fluorinated cyclic carbonate represented by formula I, and the mass percentage C % of the second compound, A %+B %+C %, is less than 30%, these three compounds cannot dominate the solvation structure of lithium ions, and the dissociation energy barrier for lithium ions remains high, resulting in no significant performance improvement. When A %+B %+C % is greater than 90%, the corresponding lithium salt concentration is low, and sufficient lithium ions cannot be provided during low-temperature and high-rate discharge, increasing polarization and deteriorating the performance of the electrochemical device. After the second compound is substituted with halogen, its ability to dissociate lithium salts decreases. If the content of the second compound is too high, lithium salts cannot be fully dissociated, increasing polarization and deteriorating the performance of the electrochemical device. If the content of the second compound is too low, the improvement effect is not significant. When the contents of the first compound, the second compound, and the fluorinated cyclic carbonate in the electrolyte meet the above requirements, the low-temperature discharge performance and high-rate discharge performance of the electrochemical device can be significantly improved.

In some embodiments, R₄₁, R₄₂, R₄₃, and R₄₄ are each independently F or an optionally F-substituted methyl, ethyl, or propyl group.

In some embodiments, R₁₁, R₁₂, R₂₁, and R₂₂ are each independently C₁-C₉ alkyl, C₁-C₈ alkyl, C₁-C₇ alkyl, C₁-C₆ alkyl, C₁-C₅ alkyl, C₁-C₄ alkyl, C₁-C₃ alkyl, or C₁-C₂ alkyl.

In some embodiments, R₁₃, R₁₄, R₂₃, and R₂₄ are each independently a substituted or unsubstituted C₁-C₁₀ alkyl, a substituted or unsubstituted C₁-C₈ alkyl, a substituted or unsubstituted C₁-C₇ alkyl, a substituted or unsubstituted C₁-C₆ alkyl, a substituted or unsubstituted C₁-C₈alkyl, a substituted or unsubstituted C₁-C₄ alkyl, a substituted or unsubstituted C₁-C₃ alkyl, or a substituted or unsubstituted C₁-C₂ alkyl, where at least one of R₁₃ or R₁₄ is substituted.

In some embodiments, 50≤(A+B+C)≤87.5. In some embodiments, the value of A+B+C is 30, 40, 45, 48, 50, 55, 60, 65, 68, 70, 72, 72.5, 75, 78, 80, 83, 85, 87.5, 90, or in a range of any two of these values.

In some embodiments, A is 5-50. In some embodiments, A is 5, 10, 15, 20, 25, 30, 35, 40, 45, 50, or in a range of any two of these values.

In some embodiments, B is 3-20. In some embodiments, 4≤B≤15. In some embodiments, B is 3, 4, 5, 8, 10, 12.5, 15, 20, or in a range of any two of these values.

In some embodiments, 2.8≤(A+C)/B≤12.

In some embodiments, a value of (A+C)/B is 2.8, 3, 5, 5.3, 6, 7, 7.5, 7.8, 8.8, 9, 9.4, 9.9, 10, 10.3, 12, or in a range of any two of these values.

When the contents of the first compound, the second compound, and the fluorinated cyclic carbonate in the electrolyte meet the above requirements, the low-temperature discharge performance and high-rate discharge performance of the electrochemical device can be further improved.

In some embodiments, the electrolyte further includes a fluoroether compound represented by formula VI:

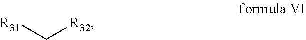

where R₃₁ and R₃₂ are each independently selected from the group consisting of a substituted or unsubstituted C₁-C₈ alkyl and —R′—O—R″;
R′ is selected from a substituted or unsubstituted C₁-C₈ alkylene;
R″ is selected from a substituted or unsubstituted C₁-C₈ alkyl;
when substituted, substituents are each independently a halogen;
and at least one of R₃₁ or R₃₂ contains F.

In some embodiments, R₃₁, R₃₂, R′, and R″ are each independently selected from the group consisting of an unsubstituted or halogen-substituted C₁-C₈ alkyl, C₁-C₇ alkyl, C₁-C₆ alkyl, C₁-C₅ alkyl, C₁-C₄ alkyl, C₁-C₃ alkyl, and C₁-C₂ alkyl.

In some embodiments, R′ is selected from the group consisting of an unsubstituted or halogen-substituted C₁-C₈ alkylene, C₁-C₇ alkylene, C₁-C₆ alkylene, C₁-C₅ alkylene, C₁-C₄ alkylene, C₁-C₃ alkylene, and C₁-C₂ alkylene.

In some embodiments, based on the mass of the electrolyte, a mass percentage of the fluoroether compound is D %, where 5≤D≤50. In some embodiments, 5≤D≤30. In some embodiments, D is 5, 10, 15, 20, 25, 30, 35, 40, 45, 50, or in a range of any two of these values.

Fluoroethers can further lower the freezing point of the electrolyte, enabling the electrolyte to maintain good fluidity at low temperatures, and improving low-temperature discharge performance. However, the ability to dissociate lithium salts is weak. If the content of fluoroether is too low, the improvement is not significant; if the content is too high, lithium salts cannot be fully dissociated, leading to increased polarization and failure to improve performance. When the content of fluoroether meets the above requirement, the low-temperature discharge performance and high-rate discharge performance of lithium-ion batteries can be significantly improved.

In some embodiments, 50≤(A+B+C+D)≤87.5. In some embodiments, 60≤(A+B+C+D)≤80. In some embodiments, a value of A+B+C+D is 50, 55, 60, 65, 70, 75, 80, 85, 87.5, or in a range of any two of these values. When A+B+C+D is within the above range, the low-temperature discharge performance and high-rate discharge performance of the electrochemical device can be further improved.

In some embodiments, the compound of formula II includes at least one selected from the group consisting of the following compounds: methyl formate, ethyl formate, methyl acetate, ethyl acetate, propyl acetate, methyl propionate, ethyl propionate, and propyl propionate.

In some embodiments, the compound of formula III includes at least one selected from the group consisting of the following compounds: dimethyl carbonate, diethyl carbonate (DEC), and ethyl methyl carbonate (EMC).

In some embodiments, the fluorinated cyclic carbonate includes at least one selected from the group consisting of the following compounds:

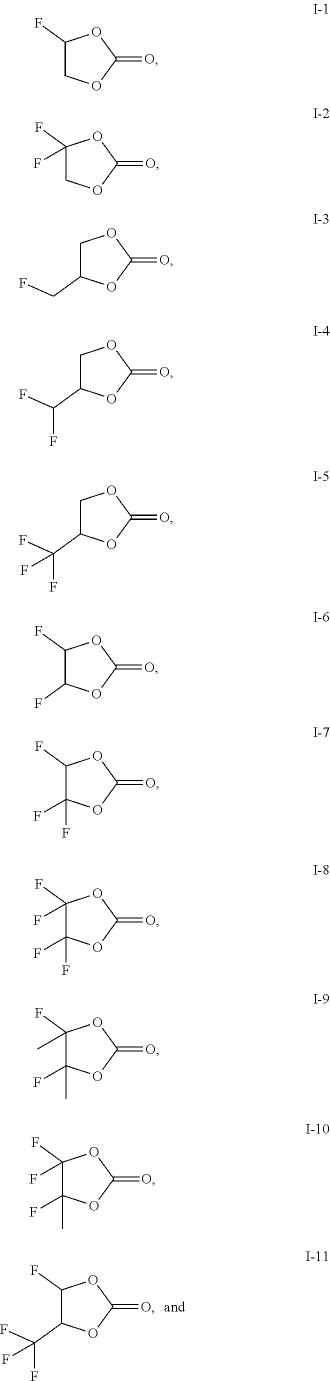

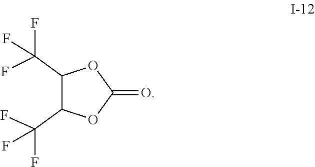 [SMILES: O=C1OC(C(F)(F)F)C(C(F)(F)F)O1]

In some embodiments, the compound of formula IV includes at least one selected from the group consisting of the following compounds:

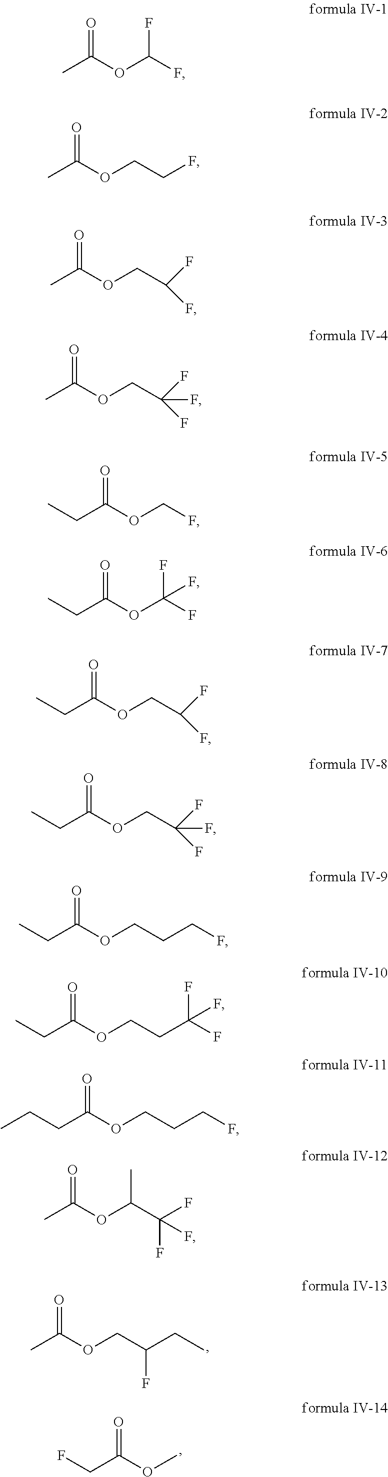

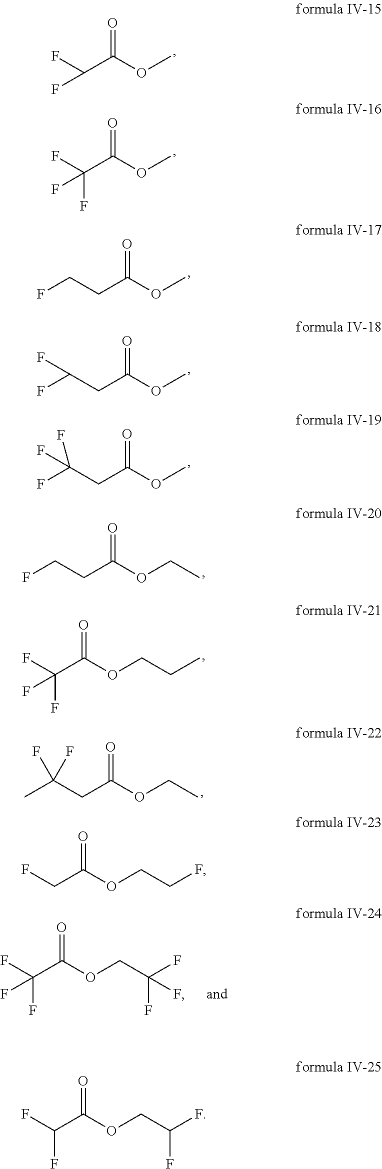

In some embodiments, the compound of formula V includes at least one selected from the group consisting of the following compounds:

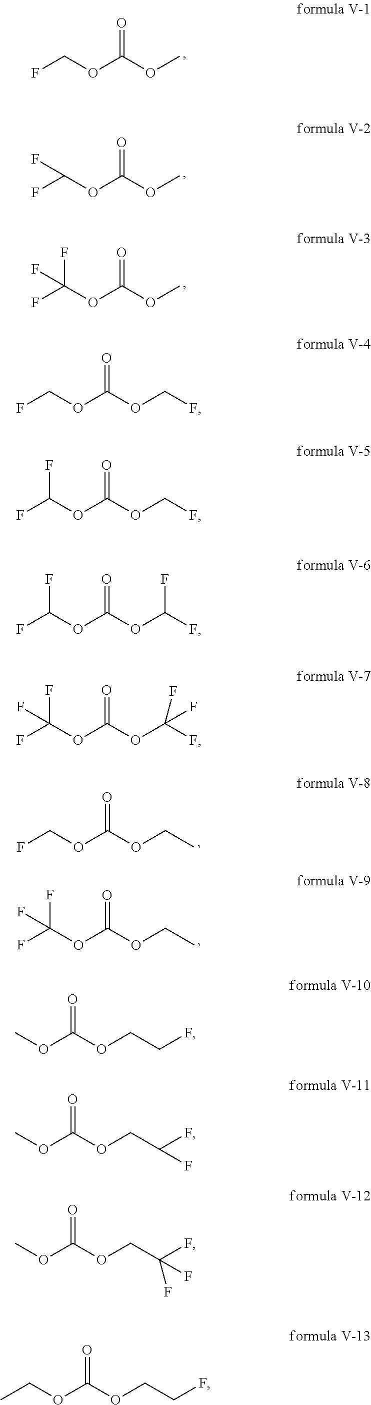

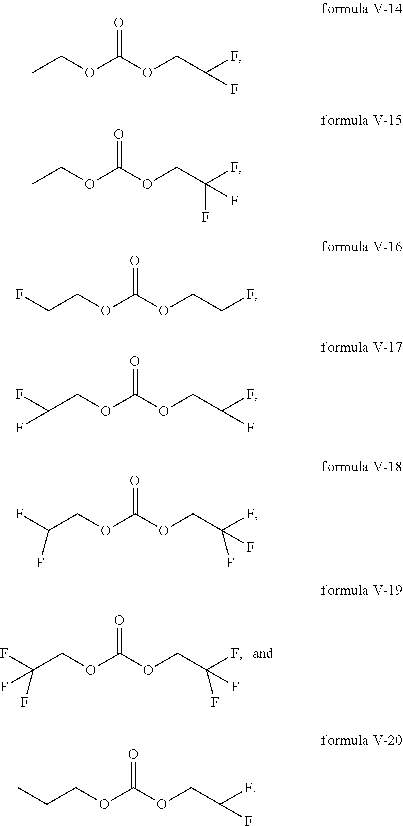

In some embodiments, the fluoroether compound includes at least one selected from the group consisting of the following compounds:

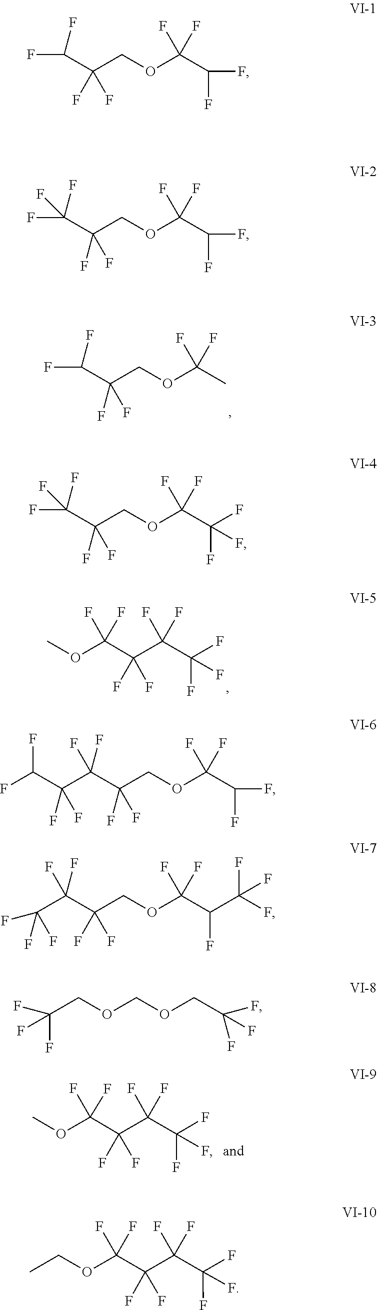

In some embodiments, the electrolyte further includes a first lithium salt, where the first lithium salt includes at least one selected from the group consisting of lithium hexafluorophosphate LiPF₆ and lithium bis(fluorosulfonyl)imide LiFSI.

In some embodiments, based on the mass of the electrolyte, a mass percentage of the first lithium salt is E %, where 2.5≤(A+B+C)/E≤8.5. In some embodiments, a value of (A+B+C)/E is 2.5, 3, 4, 5, 6, 7, 8, 8.5, or in a range of any two of these values. When the value of (A+B+C)/E is too low, a proportion of the first compound, the second compound, and the fluorinated cyclic carbonate is insufficient, and the improvement in rate performance is not significant. When the value of (A+B+C)/E is too high, the lithium salt concentration is insufficient, potentially leading to significant polarization and preventing further improvement in rate performance. When the value of (A+B+C)/E meets the above requirement, the low-temperature discharge performance and high-rate discharge performance of lithium-ion batteries can be significantly improved.

In some embodiments, E is 10-25. In some embodiments, E is 10, 12, 12.5, 15, 20, 22, 23, 25, or in a range of any two of these values.

In some embodiments, the electrolyte further includes a second lithium salt, where the second lithium salt includes at least one selected from the group consisting of the following: lithium bis(trifluoromethanesulfonyl)imide LiTFSI, lithium tetrafluoroborate LiBF₄, lithium difluoro (oxalato) borate LiDFOB, lithium bis(oxalato) borate LiBOB, and lithium difluorophosphate LiPO₂F₂. In some embodiments, based on the mass of the electrolyte, a mass percentage of the second lithium salt is 0.1% to 5%. In some embodiments, the mass percentage of the second lithium salt is 0.1%, 0.2%, 0.3%, 0.4%, 0.5%, 1%, 2%, 3%, 4%, 5%, or in a range of any two of these values.

The second lithium salt can form a low-impedance and stable interface layer, further reducing interface impedance and improving the low-temperature and rate performance of the electrochemical device. If the content of the second lithium salt is too high, continuous reactions consume lithium ions, leading to thickening of the formed interface layer and increased impedance, thereby deteriorating the rate performance of the electrochemical device. If the content of the second lithium salt is too low, the improvement effect is not significant.

In some embodiments, the electrolyte further includes a third compound, where the third compound includes at least one selected from the group consisting of the following compounds: vinylene carbonate (VC), 1,3-propane sultone (PS), succinonitrile (SN), adiponitrile (ADN), and 1,3,6-hexanetricarbonitrile (HTCN).

In some embodiments, based on the mass of the electrolyte, a mass percentage of the third compound is 0.5% to 6%. In some embodiments, the mass percentage of the third compound is 0.5%, 1%, 2%, 2.5%, 3%, 4%, 5%, 6%, or in a range of any two of these values.

The third compound can preferentially form a stable interface layer, reducing the reactions of the first compound, the fluorinated cyclic carbonate, and the second compound at the interface, thereby improving the rate performance of the electrochemical device. If the content of the third compound is too high, interface impedance is increased, deteriorating the rate performance of the electrochemical device. If the content of the third compound is too low, the improvement in rate performance is not significant.

In some embodiments, the electrolyte further includes a fourth compound, where the fourth compound includes at least one selected from the group consisting of ethylene carbonate (EC) and propylene carbonate (PC). Based on the mass of the electrolyte, a mass percentage of the fourth compound is less than or equal to 70%. In some embodiments, the mass percentage of the fourth compound is 1%, 5%, 10%, 20%, 30%, 40%, 50%, 60%, 70%, or in a range of any two of these values.

### 2. Negative Electrode

The material, composition, and manufacturing method of the negative electrode used in the electrochemical device of this application may include any technology disclosed in the prior art. In some embodiments, the negative electrode is the negative electrode described in U.S. Pat. No. 9,812,739B, which is incorporated herein by reference in its entirety.

In some embodiments, the negative electrode includes a current collector and a negative electrode active material layer disposed on the current collector. The negative electrode active material includes a material capable of reversibly intercalating/deintercalating lithium ions. In some embodiments, the material capable of reversibly intercalating/deintercalating lithium ions includes a carbon material. In some embodiments, the carbon material may be any carbon-based negative electrode active material commonly used in lithium-ion rechargeable batteries. In some embodiments, the carbon material includes, but is not limited to, crystalline carbon, amorphous carbon, or a mixture thereof. The crystalline carbon may be amorphous, flake-like, platelet-like, spherical, or fibrous natural graphite or artificial graphite. The amorphous carbon may be soft carbon, hard carbon, mesophase pitch carbide, calcined coke, or the like.

In some embodiments, the negative electrode active material layer includes a negative electrode active material. In some embodiments, the negative electrode active material includes, but is not limited to, lithium metal, structured lithium metal, natural graphite, artificial graphite, mesophase carbon microbeads (MCMB), hard carbon, soft carbon, silicon, silicon-carbon composite, Li—Sn alloy, Li—Sn—O alloy, Sn, SnO, SnO₂, spinel-structure lithiated TiO₂-Li₄TisO₁₂, Li—Al alloy, or any combination thereof.

When the negative electrode includes a silicon-carbon compound, based on the total weight of the negative electrode active material, the ratio of silicon to carbon is 1:10 to 10:1, and the median particle size Dv50 of the silicon-carbon compound is 0.1 μm to 100 μm. When the negative electrode includes an alloy material, the negative electrode active material layer may be formed using a method such as evaporation, sputtering, or plating. When the negative electrode includes lithium metal, the negative electrode active material layer is formed using, for example, a spherical twisted conductive skeleton and metal particles dispersed within the conductive skeleton. In some embodiments, the spherical twisted conductive skeleton may have a porosity of 5% to 85%. In some embodiments, a protective layer may be further disposed on the lithium metal negative electrode active material layer.

In some embodiments, the negative electrode active material layer may include a binder and optionally a conductive material. The binder enhances the bonding between negative electrode active material particles and the bonding between the negative electrode active material and the current collector. In some embodiments, the binder includes, but is not limited to, polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylic-modified styrene-butadiene rubber, epoxy resin, nylon, and the like.

In some embodiments, the conductive material includes, but is not limited to, a carbon-based material, a metal-based material, a conductive polymer, or a mixture thereof. In some embodiments, the carbon-based material is selected from the group consisting of natural graphite, artificial graphite, carbon black, acetylene black, ketjen black, carbon fiber, and any combination thereof. In some embodiments, the metal-based material is selected from the group consisting of metal powder, metal fiber, copper, nickel, aluminum, and silver. In some embodiments, the conductive polymer is a polyphenylene derivative.

In some embodiments, the current collector includes, but is not limited to, copper foil, nickel foil, stainless steel foil, titanium foil, nickel foam, copper foam, a polymer substrate coated with conductive metal, or any combination thereof.

The negative electrode can be prepared using methods known in the art. For example, the negative electrode can be obtained using the following method: mixing the active material, conductive material, and binder in a solvent to prepare an active material composition, and applying the active material composition on a current collector. In some embodiments, the solvent may include water, but is not limited thereto.

### 3. Positive Electrode

The material of the positive electrode used in the electrochemical device of this application can be prepared using materials, structures, and manufacturing methods known in the art. In some embodiments, the positive electrode of this application can be prepared using the technology described in U.S. Pat. No. 9,812,739B, which is incorporated herein by reference in its entirety.

In some embodiments, the positive electrode includes a current collector and a positive electrode active material layer disposed on the current collector. The positive electrode active material includes at least one lithiated intercalation compound capable of reversibly intercalating and deintercalating lithium ions. In some embodiments, the positive electrode active material includes a composite oxide. In some embodiments, the composite oxide contains lithium and at least one element selected from the group consisting of cobalt, manganese, and nickel.

In some embodiments, the positive electrode active material is selected from the group consisting of lithium cobalt oxide (LiCoO₂), lithium nickel cobalt manganese (NCM) ternary material, lithium iron phosphate (LiFePO₄), lithium manganese oxide (LiMn₂O₄), sodium nickel oxide (NaNiO₂), sodium metal oxides such as sodium manganese oxide (NaMnO₂), sodium iron oxide (NaFeO₂), sodium cobalt oxide (NaCoO₂), polyanionic NaMx[(XO)y]z, Prussian blue (Fe₄[Fe(CN)₆]₃), and any combination thereof.

In some embodiments, the positive electrode active material may have a coating on its surface or may be mixed with another compound having a coating. The coating may include at least one compound of a coating element selected from the group consisting of oxides of the coating element, hydroxides of the coating element, oxyhydroxides of the coating element, oxycarbonates of the coating element, and hydroxycarbonates of the coating element. The compound used for the coating may be amorphous or crystalline.

In some embodiments, the coating element contained in the coating may include Mg, Co, K, Na, Ca, Si, Ti, V, Sn, Ge, Ga, B, As, Zr, F, or any combination thereof. The coating can be applied using any method, so long as the method does not adversely affect the performance of the positive electrode active material. For example, the method may include any coating method known in the art, such as spraying and dipping.

The positive electrode active material layer further includes a binder and optionally a conductive material. The binder enhances the bonding between positive electrode active material particles and the bonding between the positive electrode active material and the current collector.

In some embodiments, the binder includes, but is not limited to, polyvinyl alcohol, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylic-modified styrene-butadiene rubber, epoxy resin, nylon, and the like.

In some embodiments, the conductive material includes, but is not limited to, a carbon-based material, a metal-based material, a conductive polymer, or a mixture thereof. In some embodiments, the carbon-based material is selected from the group consisting of natural graphite, artificial graphite, carbon black, acetylene black, ketjen black, carbon fiber, and any combination thereof. In some embodiments, the metal-based material is selected from the group consisting of metal powder, metal fiber, copper, nickel, aluminum, and silver. In some embodiments, the conductive polymer is a polyphenylene derivative.

In some embodiments, the current collector may be aluminum, but is not limited thereto.

The positive electrode can be prepared using methods known in the art. For example, the positive electrode can be obtained using the following method: mixing the active material, conductive material, and binder in a solvent to prepare an active material composition, and applying the active material composition on a current collector. In some embodiments, the solvent may include N-methylpyrrolidone, but is not limited thereto.

In some embodiments, the positive electrode is prepared by using a positive electrode active substance layer including lithium transition metal compound powder and a binder on a current collector to produce a positive electrode material.

In some embodiments, the positive electrode active substance layer can typically be prepared by the following operations: dry mixing the positive electrode active material and the binder (and optionally a conductive material and a thickener as needed) to form a sheet, and laminating the resulting sheet onto the positive electrode current collector; or dissolving or dispersing these materials in a liquid medium to produce a slurry, and applying the slurry onto the positive electrode current collector, followed by drying. In some embodiments, a material of the positive electrode active substance layer includes any material known in the art.

### 4. Separator

In some embodiments, the electrochemical device of this application includes a separator between the positive electrode and the negative electrode to prevent short circuits. The material and shape of the separator used in the electrochemical device of this application are not particularly limited, and any technology disclosed in the prior art may be used. In some embodiments, the separator includes a polymer or inorganic material produced from a material stable to the electrolyte of this application.

For example, the separator may include a substrate layer and a surface treatment layer. The substrate layer is a nonwoven fabric, film, or composite film having a porous structure, and a material of the substrate layer is selected from the group consisting of polyethylene, polypropylene, polyethylene terephthalate, polyimide, and any combination thereof. Specifically, a polypropylene porous film, a polyethylene porous film, polypropylene nonwoven fabric, polyethylene nonwoven fabric, or a polypropylene-polyethylene-polypropylene porous composite film may be used.

The surface treatment layer is disposed on at least one surface of the substrate layer, and the surface treatment layer may be a polymer layer, an inorganic layer, or a layer formed by mixing a polymer and an inorganic material. A thickness ratio of the substrate layer to the surface treatment layer is 1:1 to 20:1, the thickness of the substrate layer is 4 μm to 14 μm, and the thickness of the surface treatment layer is 1μ m to 5μ m.

The inorganic layer includes inorganic particles and a binder. The inorganic particles are selected from the group consisting of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, barium sulfate, and any combination thereof. The binder is selected from the group consisting of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, polyhexafluoropropylene, and any combination thereof. The polymer layer contains a polymer, and a material of the polymer includes at least one selected from the group consisting of polyamide, polyacrylonitrile, acrylate polymer, polyacrylic acid, polyacrylate salt, polyvinylpyrrolidone, polyvinyl ether, polyvinylidene fluoride, and poly(vinylidene fluoride-hexafluoropropylene).

### 5. Electrochemical Device

This application provides an electrochemical device including the positive electrode, negative electrode, separator, and electrolyte according to this application.

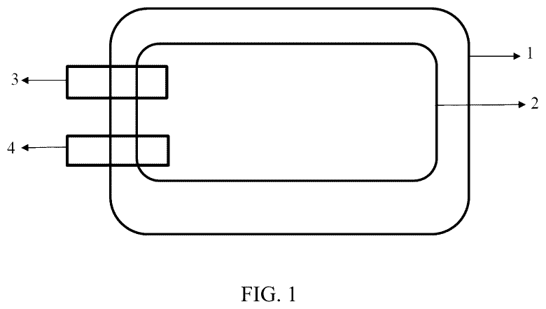

In some embodiments, the electrochemical device includes a bare cell and an outer packaging bag, where the bare cell includes a first electrode tab and a second electrode tab. FIG. 1 is a schematic structural diagram of a lithium-ion battery according to this application, which includes an outer packaging bag 1, a bare cell 2, a first electrode tab 3, and a second electrode tab 4. In some embodiments, the electrochemical device of this application includes, but is not limited to, all types of primary batteries, secondary batteries, or capacitors. In some embodiments, the electrochemical device is a lithium secondary battery. In some embodiments, the lithium secondary battery includes, but is not limited to, a lithium metal secondary battery, a lithium-ion secondary battery, a lithium polymer secondary battery, or a lithium-ion polymer secondary battery. In some embodiments, the electrochemical device is a sodium-ion battery.

### 6. Electronic Device

This application provides an electronic device including the electrochemical device according to this application.

In some embodiments, the electronic device includes, but is not limited to, a notebook computer, a pen-input computer, a mobile computer, an e-book reader, a portable phone, a portable fax machine, a portable copier, a portable printer, a stereo headset, a video recorder, a liquid crystal display television, a portable cleaner, a portable CD player, a mini disc, a transceiver, an electronic notebook, a calculator, a memory card, a portable recorder, a radio, a backup power supply, a motor, an automobile, a motorcycle, an assisted bicycle, a bicycle, a lighting fixture, a toy, a gaming console, a clock, an electric tool, a flashlight, a camera, a large household battery, or a lithium-ion capacitor.

The following uses a lithium-ion battery as an example and describes preparation of a lithium-ion battery with reference to specific examples. Those skilled in the art will understand that the preparation methods described in this application are merely examples, and any other suitable preparation methods are within the scope of this application.

### Examples

The following describes performance evaluations based on examples and comparative examples of the lithium-ion battery in this application.

### I. Preparation of Lithium-Ion Battery

Preparation of positive electrode: The positive electrode active material LiCoO₂, conductive agent carbon black (Super P), and binder polyvinylidene fluoride (PVDF) were mixed in a weight ratio of 97:1.4:1.6, and N-methylpyrrolidone (NMP) was added, followed by thorough stirring to produce a uniform positive electrode slurry, where a solid content of the positive electrode slurry was 72 wt %. The positive electrode slurry was evenly applied onto a positive electrode current collector aluminum foil, followed by drying, cold pressing, and slitting to obtain the positive electrode.

Preparation of negative electrode: The negative electrode active material artificial graphite, conductive agent carbon black (Super P), thickener sodium carboxymethyl cellulose, and binder styrene-butadiene rubber were mixed in a weight ratio of 96.4:1.5:0.5:1.6, and deionized water was added, followed by stirring to produce a uniform negative electrode slurry, where a solid content of the negative electrode slurry was 54 wt %. The negative electrode slurry was applied onto a negative electrode current collector copper foil, followed by drying, cold pressing, and slitting to obtain the negative electrode.

Preparation of separator: A 9 μm-thick polyethylene (PE) porous film was used as the separator substrate. A 2 μm-thick heat-resistant layer was applied on the surface of one side of the separator substrate (where based on the total mass of aluminum oxide and binder PVDF in the heat-resistant layer slurry, the mass percentage of aluminum oxide was 95%, and the mass percentage of PVDF was 5%). Then, the polyvinylidene fluoride (PVDF) slurry was applied on both sides, followed by drying to obtain the final separator.

Preparation of electrolyte: In a dry argon atmosphere, the components (the fourth compound, the fluorinated cyclic carbonate represented by formula I, the first compound, the second compound, and the fluoroether compound represented by formula VI) were mixed in the corresponding ratio to obtain a uniform mixed solvent. Then fully dried lithium salt was dissolved in the mixed solvent, and other corresponding additives were added, followed by thorough mixing to obtain the electrolyte. The content of each component in the electrolyte is shown in the tables below. The content of each component is expressed as a mass percentage calculated based on the mass of the electrolyte, and the sum of the contents of all components is 100%.

Preparation of lithium-ion battery: The positive electrode, separator, and negative electrode were stacked in sequence, with the separator being sandwiched between the positive electrode and negative electrode for separation. The resulting stack was wound to obtain an electrode assembly. The electrode assembly was placed in an aluminum-plastic film outer packaging and dehydrated at 80° C. Then the foregoing electrolyte was injected, and the outer packaging was sealed, followed by processes such as standing, formation, degassing, trimming, shaping, and capacity testing to obtain the lithium-ion battery.

### II. Performance Testing Methods for Lithium-Ion Battery

### (1) Test Method for Low-Temperature Discharge Capacity Retention Rate

The battery was placed in a 25° C. constant-temperature chamber, charged at a constant current of 0.5 C to 4.53 V, charged at a constant voltage of 4.53 V to 0.05 C, and then discharged at a constant current of 0.2 C to 3.4 V. A discharge capacity at this point was recorded as the initial discharge capacity D1. The battery was then charged at a constant current of 0.5 C to 4.53 V, charged at a constant voltage of 4.53 V to 0.05 C, transferred to a −20° C. constant-temperature chamber, held for 1 hour, and discharged at a constant current of 0.2 C to 3.4 V. A discharge capacity at this point was recorded as the low-temperature discharge capacity D2. The low-temperature discharge capacity retention rate of the lithium-ion battery at −20° C. and 3.4 V was calculated using the following formula:

$$Low - temperature discharge capacity retention rate = low - temperature discharge capacity D 2 / initial discharge capacity D 1 \times 100 \% .$$

### (2) Test Method for High-Rate Discharge Capacity Retention Rate

The battery was placed in a 25° C. constant-temperature chamber, charged at a constant current of 0.5 C to 4.53 V, charged at a constant voltage of 4.53 V to 0.05 C, and then discharged at a constant current of 0.2 C to 3.0 V. A discharge capacity at this point was recorded as the initial discharge capacity W1. The battery was then charged at a constant current of 0.5 C to 4.53 V, charged at a constant voltage of 4.53 V to 0.05 C, and discharged at a constant current of 4 C to 3.0 V. A discharge capacity at this point was recorded as the initial discharge capacity W2. The discharge capacity retention rate of the lithium-ion battery at 2 C was calculated using the following formula:

$$High - rate discharge capacity retention rate = high - rate discharge capacity W 2 / initial discharge capacity W 1 \times 100 \% .$$

### III. Lithium-Ion Battery Performance Test Results

The following tables present related parameters of the electrolyte and lithium-ion batteries of the examples and comparative examples. Based on the mass of the electrolyte, the mass percentage A % of the first compound is the sum of the content A1% of the compound of formula II and the content A2% of the compound of formula III, the mass percentage of the fluorinated cyclic carbonate represented by formula I is B %, and the mass percentage C % of the second compound is the sum of the content C₁% of the compound of formula IV and the content C₂% of the compound of formula V.

TABLE 1-1

| | | | | | | | | | Fluorinated cyclic | | | |
|---|---|---|---|---|---|---|---|---|---|---|---|---|
| | First compound | | | | Second compound | | | | carbonate represented | | | |
| | Compound | | Compound | | Compound | | Compound | | by formula I | | A + | |
| | of formula | Content | of formula | Content | of formula | Content | of formula | Content | | Content | B + | (A + |
| | II | A1(%) | III | A2 (%) | IV | C1(%) | V | C2 (%) | Compound | B (%) | C | C)/B |
| Example 1-1 | / | / | DEC | 20 | formula | 50 | / | / | I-1 | 8 | 78 | 8.8 |
| | | | | | IV-3 | | | | | | | |
| Example 1-2 | / | / | DEC | 20 | formula | 50 | / | / | I-1 | 8 | 78 | 8.8 |
| | | | | | IV-4 | | | | | | | |
| Example 1-3 | / | / | DEC | 20 | formula | 50 | / | / | I-1 | 8 | 78 | 8.8 |
| | | | | | IV-18 | | | | | | | |
| Example 1-4 | Propyl | 25 | / | / | formula | 50 | / | / | I-1 | 10 | 85 | 7.5 |
| | propionate | | | | IV-3 | | | | | | | |
| Example 1-5 | Ethyl | 25 | / | / | formula | 50 | / | / | I-1 | 10 | 85 | 7.5 |
| | propionate | | | | IV-3 | | | | | | | |
| Example 1-6 | Ethyl | 15 | DEC | 10 | formula | 50 | / | / | I-1 | 8 | 83 | 9.4 |
| | propionate | | | | IV-3 | | | | | | | |
| Example 1-7 | / | / | DEC | 5 | formula | 20 | / | / | IV-1 | 5 | 30 | 5.0 |
| | | | | | IV-3 | | | | | | | |
| Example 1-8 | / | / | DEC | 10 | formula | 25 | / | / | I-1 | 8 | 43 | 4.4 |
| | | | | | IV-3 | | | | | | | |
| Example 1-9 | / | / | DEC | 10 | formula | 32 | / | / | I-1 | 8 | 50 | 5.3 |
| | | | | | IV-3 | | | | | | | |
| Example 1-10 | / | / | DEC | 10 | formula | 52 | / | / | I-1 | 8 | 70 | 7.8 |
| | | | | | IV-3 | | | | | | | |
| Example 1-11 | / | / | DEC | 10 | formula | 61 | / | / | I-1 | 8 | 79 | 8.9 |
| | | | | | IV-3 | | | | | | | |
| Example 1-12 | / | / | DEC | 20 | formula | 52 | / | / | I-1 | 8 | 80 | 9 |
| | | | | | IV-3 | | | | | | | |
| Example 1-13 | / | / | DEC | 30 | formula | 52 | / | / | I-1 | 8 | 90 | 10.3 |
| | | | | | IV-3 | | | | | | | |
| Example 1-14 | Propyl | 30 | / | / | / | / | formula | 30 | I-1 | 8 | 68 | 7.5 |
| | propionate | | | | | | V-15 | | | | | |
| Example 1-15 | Propyl | 30 | / | / | / | / | formula | 30 | IV-1 | 8 | 68 | 7.5 |
| | propionate | | | | | | V-19 | | | | | |
| Example 1-16 | Propyl | 30 | / | / | / | / | formula | 30 | I-1 | 8 | 68 | 7.5 |
| | propionate | | | | | | V-11 | | | | | |
| Example 1-17 | / | / | EMC | 30 | formula | 12.5 | formula | 30 | I-1 | 8 | 80.5 | 9.1 |
| | | | | | IV-4 | | V-15 | | | | | |
| Example 1-18 | / | / | DEC | 18.5 | formula | 61 | / | / | I-4 | 8 | 87.5 | 9.9 |
| | | | | | IV-3 | | | | | | | |
| Example 1-19 | / | / | DEC | 18.5 | formula | 61 | / | / | I-6 + I-1 | 3 + 5 | 87.5 | 9.9 |
| | | | | | IV-3 | | | | | | | |
| Example 1-20 | Propyl | 20 | / | / | formula | 40 | / | / | I-1 | 5 | 65 | 12 |
| | propionate | | | | IV-3 | | | | | | | |
| Example 1-21 | Propyl | 25 | / | / | formula | 50 | / | / | I-1 | 12.5 | 87.5 | 6 |
| | propionate | | | | IV-3 | | | | | | | |
| Example 1-22 | Propyl | 25 | / | / | formula | 50 | / | / | I-1 | 15 | 90 | 5 |
| | propionate | | | | IV-3 | | | | | | | |
| Comparative | Propyl | 40 | / | / | / | / | / | / | I-1 | 8 | 48 | 5 |
| Example 1 | propionate | | | | | | | | | | | |
| Comparative | Propyl | 40 | / | / | formula | 30 | / | / | / | / | 70 | / |
| Example 2 | propionate | | | | IV-3 | | | | | | | |
| Comparative | / | / | / | / | formula | 30 | formula | 30 | I-1 | 8 | 68 | 7.5 |
| Example 3 | | | | | IV-3 | | V-3 | | | | | |
| Comparative | Propyl | 10 | / | / | formula | 10 | / | / | I-1 | 8 | 28 | 2.5 |
| Example 4 | propionate | | | | IV-3 | | | | | | | |
| Comparative | Propyl | 40 | / | / | formula | 45 | / | / | I-1 | 7 | 92 | 13.6 |
| Example 5 | propionate | | | | IV-3 | | | | | | | |

“/” indicates that the substance or parameter does not exist.

TABLE 1-2

| | | | | | | Low- | High-rate |
|---|---|---|---|---|---|---|---|
| | | | | | | temperature | discharge |
| | Fourth compound | | First lithium salt | | (A + | discharge | capacity |
| | | Content | Lithium | Content E | B + | capacity | retention |
| | Compound | (%) | salt | (%) | C)/E | retention rate | rate |
| Example 1-1 | PC | 9.5 | LiPF₆ | 12.5 | 6.24 | 68.40% | 79.30% |
| Example 1-2 | PC | 9.5 | LiPF₆ | 12.5 | 6.24 | 65.50% | 70.10% |
| Example 1-3 | PC | 9.5 | LiPF₆ | 12.5 | 6.24 | 61.00% | 72.20% |
| Example 1-4 | PC | 2.5 | LiPF₆ | 12.5 | 6.8 | 69.50% | 78.50% |
| Example 1-5 | PC | 2.5 | LiPF₆ | 12.5 | 6.8 | 62.50% | 67.50% |
| Example 1-6 | PC | 4.5 | LiPF₆ | 12.5 | 6.64 | 64.90% | 71.50% |
| Example 1-7 | EC + PC | 30 + 14.5 | LiPF₆ | 12.5 | 2.4 | 49.10% | 53.90% |
| Example 1-8 | EC + PC | 30 + 14.5 | LiPF₆ | 12.5 | 3.44 | 59.50% | 63.40% |
| Example 1-9 | EC + PC | 20 + 17.5 | LiPF₆ | 12.5 | 4 | 65.50% | 70.30% |
| Example 1-10 | PC | 17.5 | LiPF₆ | 12.5 | 5.6 | 70.30% | 80.20% |
| Example 1-11 | PC | 8.5 | LiPF₆ | 12.5 | 6.32 | 61.20% | 72.40% |
| Example 1-12 | PC | 7.5 | LiPF₆ | 12.5 | 6.4 | 72.30% | 84.30% |
| Example 1-13 | / | / | LiPF₆ | 10 | 7.2 | 65.30% | 68.40% |
| Example 1-14 | EC + PC | 10 + 9.5 | LiPF₆ | 12.5 | 5.44 | 69.30% | 76.90% |
| Example 1-15 | EC + PC | 10 + 9.5 | LiPF₆ | 12.5 | 5.44 | 66.50% | 72.10% |
| Example 1-16 | EC + PC | 10 + 9.5 | LiPF₆ | 12.5 | 5.44 | 64.90% | 73.40% |
| Example 1-17 | PC | 7 | LiPF₆ | 12.5 | 6.44 | 67.20% | 74.30% |
| Example 1-18 | / | / | LiPF₆ | 12.5 | 7 | 64.50% | 76.40% |
| Example 1-19 | / | / | LiPF₆ | 12.5 | 7 | 66.10% | 74.40% |
| Example 1-20 | EC + PC | 10 + 12.5 | LiPF₆ | 12.5 | 5.2 | 57.20% | 60.20% |
| Example 1-21 | / | / | LiPF₆ | 12.5 | 7 | 71.50% | 79.90% |
| Example 1-22 | / | / | LiPF₆ | 10.5 | 7.2 | 62.10% | 65.40% |
| Comparative | EC + PC | 20 + 19.5 | LiPF₆ | 12.5 | 3.84 | 28.50% | 40.30% |
| Example 1 | | | | | | | |
| Comparative | PC | 17.5 | LiPF₆ | 12.5 | 5.6 | 27.60% | 39.70% |
| Example 2 | | | | | | | |
| Comparative | PC | 19.5 | LiPF₆ | 12.5 | 5.44 | 30.70% | 35.20% |
| Example 3 | | | | | | | |
| Comparative | EC + PC | 30 + 29.5 | LiPF₆ | 12.5 | 2.24 | 26.50% | 28.40% |
| Example 4 | | | | | | | |
| Comparative | / | / | LiPF₆ | 8 | 7.36 | 28.60% | 31.50% |
| Example 5 | | | | | | | |

“/” indicates that the substance or parameter does not exist.

From Table 1-1 and Table 1-2, it can be seen that the electrolytes in Examples 1-1 to 1-22 contain the first compound, the second compound, and the fluorinated cyclic carbonate represented by formula I, and the mass percentage A % of the first compound, the mass percentage B % of the fluorinated cyclic carbonate represented by formula I, and the mass percentage C % of the second compound, where 30≤(A+B+C)≤90 and 20≤C≤61. Therefore, the lithium-ion batteries in Examples 1-1 to 1-22 exhibit significantly improved low-temperature discharge performance and high-rate discharge performance.

Compared to Examples 1-1 to 1-22, the electrolyte in Comparative Example 1 has significantly deteriorated low-temperature discharge performance and high-rate discharge performance due to lack of the second compound.

Compared to Examples 1-1 to 1-22, the electrolyte in Comparative Example 2 has significantly deteriorated low-temperature discharge performance and high-rate discharge performance due to lack of the fluorinated cyclic carbonate represented by formula I.

Compared to Examples 1-1 to 1-22, the electrolyte in Comparative Example 3 has significantly deteriorated low-temperature discharge performance and high-rate discharge performance due to lack of the first compound.

Compared to Examples 1-1 to 1-22, the electrolyte in Comparative Example 4 has an A+B+C value of less than 30, resulting in significantly deteriorated low-temperature discharge performance and high-rate discharge performance.

Compared to Examples 1-1 to 1-22, the electrolyte in Comparative Example 5 has an A+B+C value of greater than 90, resulting in significantly deteriorated low-temperature discharge performance and high-rate discharge performance.

The above Examples and Comparative Examples demonstrate that when the electrolyte contains the first compound, the second compound, and the fluorinated cyclic carbonate represented by formula I, the sum of the contents of the three is in the range of 30% to 90%, and the mass percentage C % of the second compound is in the range of 20 to 60, the low-temperature discharge performance and high-rate discharge performance of the lithium-ion batteries are significantly improved.

The lithium-ion batteries of Examples 2-1 to 2-5 in Table 2-1 and Table 2-2 have the same composition conditions as Example 1-4 except for the parameters shown in Table 2-1 and Table 2-2. The lithium-ion batteries of Examples 2-6 to 2-9 in Table 2-1 and Table 2-2 have the same composition conditions as Example 1-9 except for the parameters shown in Table 2-1 and Table 2-2.

TABLE 2-1

| | | | | | | | Fluorinated cyclic | | | | |
|---|---|---|---|---|---|---|---|---|---|---|---|
| | | | | | | | carbonate | | | | |
| | | | | | | | represented by | | Fluoroether | | |
| | First compound | | | | Second compound | | formula I | | compound | | A + |
| | Compound | | Compound | | Compound | | Compound | | Compound | | B + |
| | of formula | Content | of formula | Content | of formula | Content | of formula | Content | of formula | Content | C + |
| Example | II | A1 (%) | III | A2 (%) | IV | C1 (%) | I | B (%) | VI | D (%) | D |
| Example 1-4 | Propyl | 25 | / | / | formula | 50 | I-1 | 10 | / | / | 85 |
| | propionate | | | | IV-3 | | | | | | |
| Example 2-1 | Propyl | 25 | / | / | formula | 45 | I-1 | 10 | VI-1 | 5 | 85 |
| | propionate | | | | IV-3 | | | | | | |
| Example 2-2 | Propyl | 25 | / | / | formula | 35 | I-1 | 10 | VI-1 | 15 | 85 |
| | propionate | | | | IV-3 | | | | | | |
| Example 2-3 | Propyl | 25 | / | / | formula | 20 | I-1 | 10 | VI-1 | 30 | 85 |
| | propionate | | | | IV-3 | | | | | | |
| Example 2-4 | Propyl | 25 | / | / | formula | 35 | I-1 | 10 | VI-6 | 15 | 85 |
| | propionate | | | | IV-3 | | | | | | |
| Example 2-5 | Propyl | 25 | / | / | formula | 47 | I-1 | 10 | VI-1 | 3 | 85 |
| | propionate | | | | IV-3 | | | | | | |
| Example 1-9 | / | / | DEC | 10 | formula | 32 | I-1 | 8 | / | / | 50 |
| | | | | | IV-3 | | | | | | |
| Example 2-6 | / | / | DEC | 10 | formula | 32 | I-1 | 8 | VI-1 | 10 | 60 |
| | | | | | IV-3 | | | | | | |
| Example 2-7 | / | / | DEC | 10 | formula | 32 | I-1 | 8 | VI-1 | 20 | 70 |
| | | | | | IV-3 | | | | | | |
| Example 2-8 | / | / | DEC | 10 | formula | 32 | I-1 | 8 | VI-1 | 30 | 80 |
| | | | | | IV-3 | | | | | | |
| Example 2-9 | / | / | DEC | 17.5 | formula | 32 | I-1 | 8 | VI-1 | 30 | 87.5 |
| | | | | | IV-3 | | | | | | |

“/” indicates that the substance or parameter does not exist.

TABLE 2-2

| | | | | | Low-temperature | High-rate |
|---|---|---|---|---|---|---|
| | Fourth compound | | First lithium salt | | discharge | discharge |
| | | Content | Lithium | Content | capacity | capacity |
| Example | Compound | (%) | salt | (%) | retention rate | retention rate |
| Example 1-4 | PC | 2.5 | LiPF₆ | 12.5 | 69.50% | 78.50% |
| Example 2-1 | PC | 2.5 | LiPF₆ | 12.5 | 70.30% | 79.70% |
| Example 2-2 | PC | 2.5 | LiPF₆ | 12.5 | 74.40% | 83.80% |
| Example 2-3 | PC | 2.5 | LiPF₆ | 12.5 | 71.20% | 81.40% |
| Example 2-4 | PC | 2.5 | LiPF₆ | 12.5 | 72.10% | 82.10% |
| Example 2-5 | PC | 2.5 | LiPF₆ | 12.5 | 68.50% | 76.30% |
| Example 1-9 | EC + PC | 20 + 17.5 | LiPF₆ | 12.5 | 65.50% | 70.30% |
| Example 2-6 | EC + PC | 10 + 17.5 | LiPF₆ | 12.5 | 70.40% | 74.20% |
| Example 2-7 | PC | 17.5 | LiPF₆ | 12.5 | 72.50% | 75.90% |
| Example 2-8 | PC | 7.5 | LiPF₆ | 12.5 | 74.10% | 76.20% |
| Example 2-9 | / | / | LiPF₆ | 12.5 | 70.70% | 74.40% |

“/” indicates that the substance or parameter does not exist.

From the comparison of Examples 2-1 to 2-5 with Example 1-4 and comparison of Examples 2-6 to 2-9 with Example 1-9, it can be seen that when the electrolyte contains the first compound, the second compound, and the fluorinated cyclic carbonate represented by formula I, and the mass percentage A % of the first compound, the mass percentage B % of the fluorinated cyclic carbonate represented by formula I, and the mass percentage C % of the second compound, where 30≤(A+B+C)≤90 and 20≤C≤61, adding a fluoroether compound with a mass percentage of 5% to 30% to the electrolyte further improves the low-temperature discharge performance and high-rate discharge performance of the lithium-ion batteries.

In Table 3, the lithium-ion batteries of Examples 3-1 to 3-9 have the same composition conditions as Example 1-4 except for the parameters shown in Table 3.

TABLE 3

| | | | | | | | | | | | | | | Low- | |
|---|---|---|---|---|---|---|---|---|---|---|---|---|---|---|---|
| | | | | | | | | | | | | | | temper- | High- |
| | First | | Second | | Fluorinated | | | | | | | | | ature | rate |
| | compound | | compound | | cyclic carbonate | | | | | | | | | dis- | dis- |
| | Com- | | Com- | | represented by | | First | | Second | | | Fourth | | charge | charge |
| | pound | Con- | pound | Con- | formula I | | lithium salt | | lithium salt | | | compound | | capacity | capacity |
| | of | tent | of | tent | | Con- | | Con- | | Con- | (A + | | Con- | reten- | reten- |
| | formula | A1 | formula | C1 | Com- | tent | Com- | tent | Com- | tent | B + | Com- | tent | tion | tion |
| | II | (%) | IV | (%) | pound | B(%) | pound | E (%) | pound | (%) | C)/E | pound | (%) | rate | rate |
| Example | Propyl | 25 | formula | 50 | I-1 | 10 | LiPF₆ | 12.5 | / | / | 6.8 | PC | 2.5 | 69.50% | 78.50% |
| 1-4 | propionate | | IV-3 | | | | | | | | | | | | |
| Example | Propyl | 25 | formula | 50 | I-1 | 10 | LiPF₆ | 10 | / | / | 8.5 | PC | 5 | 71.50% | 79.10% |
| 3-1 | propionate | | IV-3 | | | | | | | | | | | | |
| Example | Propyl | 25 | formula | 50 | I-1 | 10 | LiPF₆ + | 10 + | / | / | 6.8 | PC | 2.5 | 74.30% | 80.40% |
| 3-2 | propionate | | IV-3 | | | | LiFSI | 2.5 | | | | | | | |
| Example | Propyl | 25 | formula | 42.5 | I-1 | 10 | LiPF₆ + | 12.5 + | / | / | 3.9 | PC | 2.5 | 74.10% | 81.10% |
| 3-3 | propionate | | IV-3 | | | | LiFSI | 7.5 | | | | | | | |
| Example | Propyl | 40 | formula | 40 | I-1 | 10 | LiPF₆ | 10 | / | / | 9 | / | / | 68.20% | 77.90% |
| 3-4 | propionate | | IV-3 | | | | | | | | | | | | |
| Example | Propyl | 25 | formula | 45 | I-1 | 10 | LiPF₆ | 12.5 | LiTFSI | 5 | 6.4 | PC | 2.5 | 73.90% | 82.40% |
| 3-5 | propionate | | IV-3 | | | | | | | | | | | | |
| Example | Propyl | 25 | formula | 49.8 | I-1 | 10 | LiPF₆ | 12.5 | LiBF₄ | 0.1 | 6.8 | PC | 2.5 | 71.70% | 80.10% |
| 3-6 | propionate | | IV-3 | | | | | | | | | | | | |
| Example | Propyl | 25 | formula | 49.5 | I-1 | 10 | LiPF₆ | 12.5 | LiBOB | 0.5 | 6.8 | PC | 2.5 | 71.20% | 80.90% |
| 3-7 | propionate | | IV-3 | | | | | | | | | | | | |
| Example | Propyl | 25 | formula | 49.5 | I-1 | 10 | LiPF₆ | 12.5 | LiPO₂F₂ | 0.5 | 6.8 | PC | 2.5 | 71.90% | 81.30% |
| 3-8 | propionate | | IV-3 | | | | | | | | | | | | |
| Example | Propyl | 25 | formula | 49 | I-1 | 10 | LiPF₆ | 12.5 | LiPO₂F₂ | 1 | 6.7 | PC | 2.5 | 72.70% | 82.20% |
| 3-9 | propionate | | IV-3 | | | | | | | | | | | | |

“/” indicates that the substance or parameter does not exist.

From the comparison of Examples 3-1 and 3-9 with Example 1-4, it can be seen that when the electrolyte contains the first compound, the second compound, and the fluorinated cyclic carbonate represented by formula I, and the mass percentage A % of the first compound, the mass percentage B % of the fluorinated cyclic carbonate represented by formula I, and the mass percentage C % of the second compound, where 30≤(A+B+C)≤90 and 20≤C≤61, adding the first lithium salt with a mass percentage E %, where 2.5≤(A+B+C)/E≤8.5, into the electrolyte further improves the low-temperature discharge performance and high-rate discharge performance of the lithium-ion batteries.

Furthermore, from the comparison of Examples 3-2 and 3-3 with Examples 1-4 and 3-1, it can be seen that adding LiFSI to an electrolyte containing specific contents of the first compound, the second compound, the fluorinated cyclic carbonate represented by formula I, and LiPF₆ can significantly improve the low-temperature discharge performance and high-rate discharge performance of the lithium-ion batteries.

Additionally, from the comparison of Examples 3-5 to 3-9 with Examples 1-4, 3-1, and 3-2, it can be seen that adding the second lithium salt (at least one of LiTFSI, LiBF₄, LiBOB, or LiPO₂F₂) to an electrolyte containing specific contents of the first compound, the second compound, the fluorinated cyclic carbonate represented by formula I, and the first lithium salt can significantly improve the low-temperature discharge performance and high-rate discharge performance of the lithium-ion batteries.

In Table 4, the lithium-ion batteries of Examples 4-1 to 4-6 have the same composition conditions as Example 1-4 except for the parameters shown in Table 4.

TABLE 4

| | | | | | | | | | | | | Low- | |
|---|---|---|---|---|---|---|---|---|---|---|---|---|---|
| | | | | | Fluorinated | | | | | | | temper- | |
| | First compound | | Second compound | | cyclic carbonate | | | | | | | ature | High-rate |
| | Com- | Con- | Com- | Con- | represented | | Third compound | | Fourth compound | | | discharge | discharge |
| | pound of | tent | pound of | tent | by formula I | | | Con- | | Con- | | capacity | capacity |
| | formula | A1 | formula | C1 | Com- | Content | Com- | tent | Com- | tent | | retention | retention |
| | II | (%) | IV | (%) | pound | B (%) | pound | (%) | pound | (%) | LiPF₆ | rate | rate |
| Example | Propyl | 25 | formula | 50 | I-1 | 10 | / | / | PC | 2.5 | 12.50% | 69.50% | 78.50% |
| 1-4 | propionate | | IV-3 | | | | | | | | | | |
| Example | Propyl | 25 | formula | 49.5 | I-1 | 10 | VC | 0.5 | PC | 2.5 | 12.50% | 70.70% | 79.10% |
| 4-1 | propionate | | IV-3 | | | | | | | | | | |
| Example | Propyl | 25 | formula | 47.5 | I-1 | 10 | PS | 2.5 | PC | 2.5 | 12.50% | 71.20% | 79.60% |
| 4-2 | propionate | | IV-3 | | | | | | | | | | |
| Example | Propyl | 25 | formula | 48 | I-1 | 10 | SN | 2 | PC | 2.5 | 12.50% | 71.40% | 80.20% |
| 4-3 | propionate | | IV-3 | | | | | | | | | | |
| Example | Propyl | 25 | formula | 48 | I-1 | 10 | ADN | 2 | PC | 2.5 | 12.50% | 71.70% | 80.70% |
| 4-4 | propionate | | IV-3 | | | | | | | | | | |
| Example | Propyl | 25 | formula | 49 | I-1 | 10 | HTCN | 1 | PC | 2.5 | 12.50% | 71.50% | 79.80% |
| 4-5 | propionate | | IV-3 | | | | | | | | | | |
| Example | Propyl | 25 | formula | 44 | I-1 | 10 | SN + | 2 + | PC | 2.5 | 12.50% | 72.90% | 80.30% |
| 4-6 | propionate | | IV-3 | | | | ADN + | 2 + 2 | | | | | |
| | | | | | | | HTCN | | | | | | |

“/” indicates that the substance or parameter does not exist.

From the comparison of Examples 4-1 to 4-6 with Example 1-4, it can be seen that when the electrolyte contains the first compound, the second compound, and the fluorinated cyclic carbonate represented by formula I, and the mass percentage A % of the first compound, the mass percentage B % of the fluorinated cyclic carbonate represented by formula I, and the mass percentage C % of the second compound, where 30≤(A+B+C)≤90 and 20≤C≤61, adding the third compound with a mass percentage of 0.5% to 6% to the electrolyte further improves the low-temperature discharge performance and high-rate discharge performance of the lithium-ion batteries.

Throughout the specification, references to “some embodiments”, “certain embodiments”, “one embodiment”, “another example”, “example”, “specific example”, or “certain examples” mean that at least one embodiment or example of this application includes the specific features, structures, materials, or characteristics described in that embodiment or example. Therefore, descriptions appearing throughout the specification, such as “in some embodiments”, “in embodiments”, “in one embodiment”, “in another example”, “in an example”, “in a specific example”, or “example”, do not necessarily refer to the same embodiment or example in this application. Furthermore, the specific features, structures, materials, or characteristics described herein may be combined in any suitable manner in one or more embodiments or examples.

Although illustrative embodiments have been demonstrated and described, those skilled in the art should understand that the above embodiments are not to be construed as limiting the application, and changes, substitutions, and modifications may be made to the embodiments without departing from the spirit, principles, and scope of this application.

What is claimed is:

1. An electrolyte, comprising:
(1) a fluorinated cyclic carbonate represented by formula I: 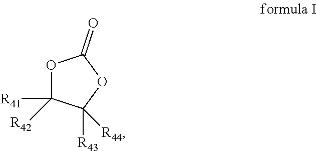
wherein R₄₁, R₄₂, R₄₃, and R₄₄ are each independently F or a substituted or unsubstituted C₁-C₃ alkyl; when substituted, substituents are each independently a halogen; wherein at least one of R₄₁, R₄₂, R₄₃, or R₄₄ contains F;
(2) a first compound, wherein the first compound comprises at least one of a compound of formula II or a compound of formula III: 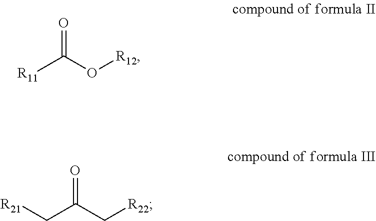
wherein R₁₁, R₁₂, R₂₁, and R₂₂ are each independently a C₁-C₁₀ alkyl; and
(3) a second compound, wherein the second compound comprises at least one of a compound of formula IV or a compound of formula V: 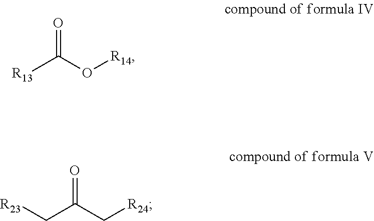
wherein:
R₁₃ and R₁₄ are each independently a substituted or unsubstituted C₁-C₁₀ alkyl, wherein at least one of R₁₃ or R₁₄ is substituted;
R₂₃ and R₂₄ are each independently a substituted or unsubstituted C₁-C₁₀ alkyl, wherein at least one of R₂₃ or R₂₄ is substituted;
when substituted, substituents are each independently a halogen; and
based on a mass of the electrolyte, a mass percentage of the first compound is A %, a mass percentage of the fluorinated cyclic carbonate is B %, and a mass percentage of the second compound is C %, wherein 30≤(A+B+C)≤90 and 20≤C≤61.

2. The electrolyte according to claim 1, wherein 50≤(A+B+C)≤87.5.

3. The electrolyte according to claim 1, wherein 4≤B≤15.

4. The electrolyte according to claim 1, wherein 2.8≤(A+C)/B≤12.

5. The electrolyte according to claim 1, wherein the electrolyte further comprises a fluoroether compound represented by formula VI: 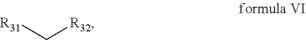
wherein R₃₁ and R₃₂ are each independently selected from the group consisting of a substituted or unsubstituted C₁-C₈ alkyl and —R′—O—R″;
R′ is selected from a substituted or unsubstituted C₁-C₈ alkylene;
R″ is selected from a substituted or unsubstituted C₁-C₈ alkyl;
when substituted, substituents are each independently a halogen;
at least one of R₃₁ or R₃₂ comprises F; and
based on the mass of the electrolyte, a mass percentage of the fluoroether compound is D %, wherein 5≤D≤30.

6. The electrolyte according to claim 5, wherein 50≤(A+B+C+D)≤87.5.

7. The electrolyte according to claim 5, wherein 60≤(A+B+C+D)≤80.

8. The electrolyte according to claim 1, wherein:
the compound of formula II comprises at least one selected from the group consisting of the following compounds: methyl formate, ethyl formate, methyl acetate, ethyl acetate, propyl acetate, methyl propionate, ethyl propionate, and propyl propionate; and/or
the compound of formula III comprises at least one selected from the group consisting of the following compounds: dimethyl carbonate, diethyl carbonate, and ethyl methyl carbonate.

9. The electrolyte according to claim 1, wherein the fluorinated cyclic carbonate comprises at least one selected from the group consisting of the following compounds:

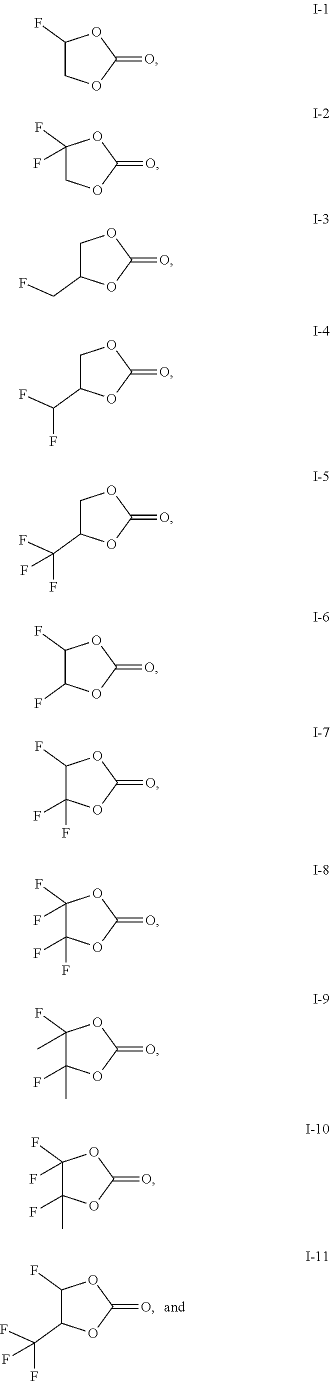

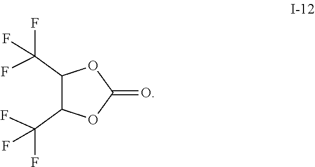 [SMILES: O=C1OC(C(F)(F)F)C(C(F)(F)F)O1]

10. The electrolyte according to claim 1, wherein the compound of formula IV comprises at least one selected from the group consisting of the following compounds: 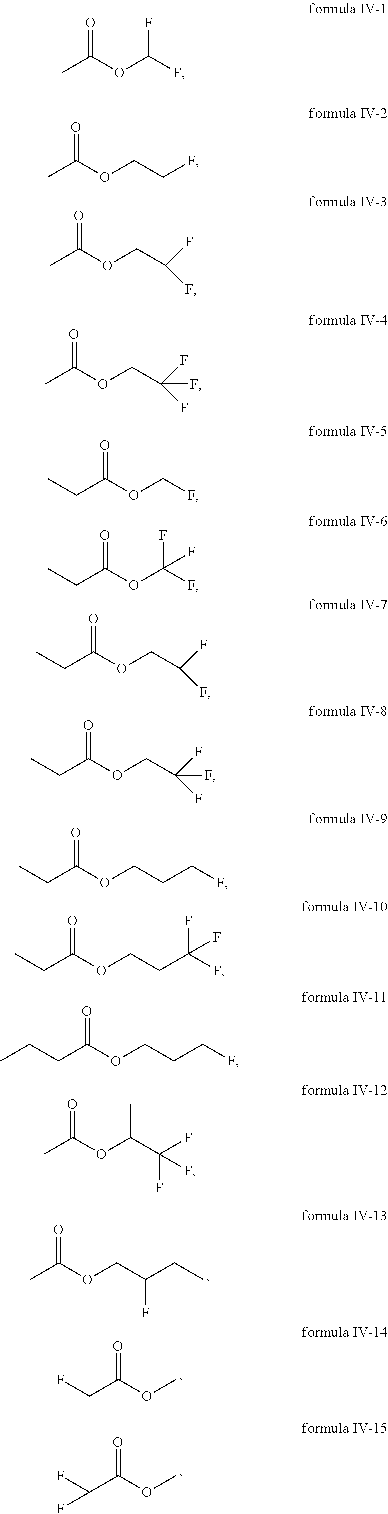 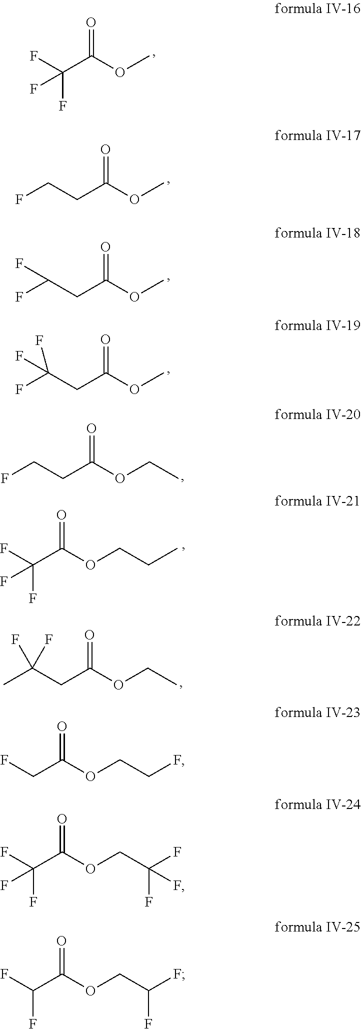
and/or
the compound of formula V comprises at least one selected from the group consisting of the following compounds:

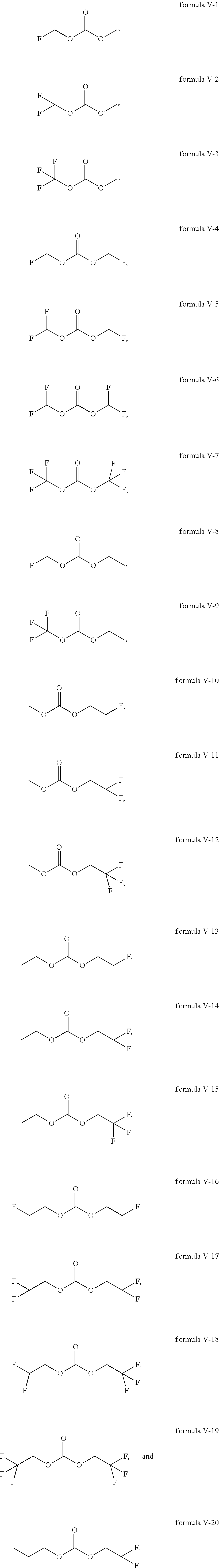

11. The electrolyte according to claim 5, wherein the fluoroether compound comprises at least one selected from the group consisting of the following compounds:

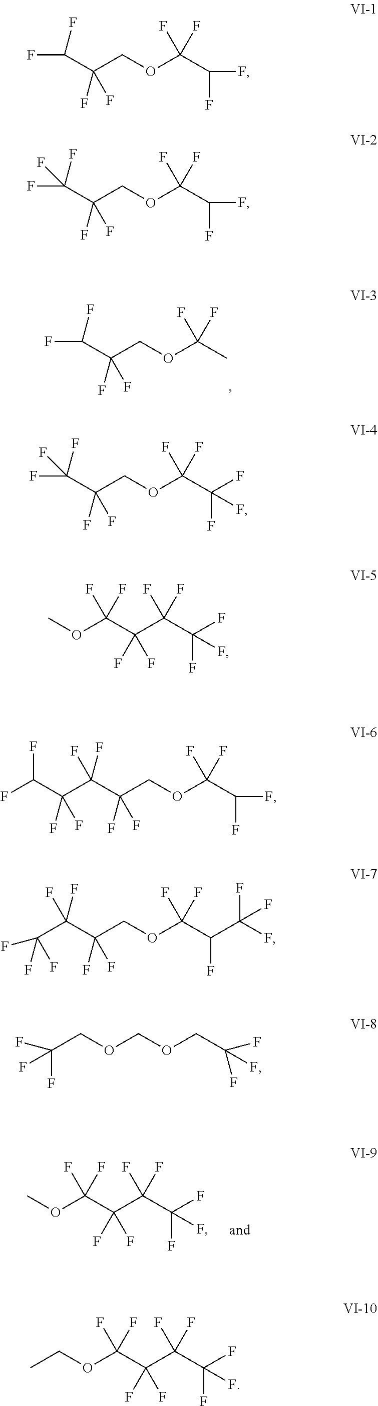

12. The electrolyte according to claim 1, wherein the electrolyte further comprises a first lithium salt; wherein the first lithium salt comprises at least one selected from the group consisting of lithium hexafluorophosphate LiPF₆ and lithium bis(fluorosulfonyl)imide LiFSI; and
based on the mass of the electrolyte, a mass percentage of the first lithium salt is E %, wherein 2.5≤(A+B+C)/E≤8.5.

13. The electrolyte according to claim 12, wherein the electrolyte further comprises a second lithium salt; wherein the second lithium salt comprises at least one selected from the group consisting of the following: lithium bis(trifluoromethanesulfonyl)imide (LiTFSI), lithium tetrafluoroborate (LiBF₄), lithium difluoro (oxalato) borate (LiDFOB), lithium bis(oxalato) borate (LiBOB), and lithium difluorophosphate (LiPO₂F₂);
wherein based on the mass of the electrolyte, a mass percentage of the second lithium salt is 0.1% to 5%.

14. The electrolyte according to claim 1, wherein the electrolyte further comprises a third compound; wherein the third compound comprises at least one selected from the group consisting of the following compounds: vinylene carbonate, 1,3-propane sultone, succinonitrile, adiponitrile, and 1,3,6-hexanetricarbonitrile;
wherein based on the mass of the electrolyte, a mass percentage of the third compound is 0.5% to 6%.

15. An electrochemical device, comprising: a positive electrode, a negative electrode, a separator, and an electrolyte; the electrolyte comprising:
(1) a fluorinated cyclic carbonate represented by formula I: 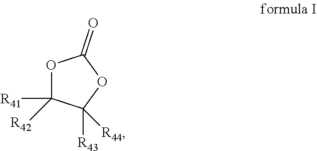
wherein R₄₁, R₄₂, R₄₃, and R₄₄ are each independently F or a substituted or unsubstituted C₁-C₃ alkyl; when substituted, substituents are each independently a halogen; wherein at least one of R₄₁, R₄₂, R₄₃, or R₄₄ contains F;
(2) a first compound, wherein the first compound comprises at least one of a compound of formula II or a compound of formula III: 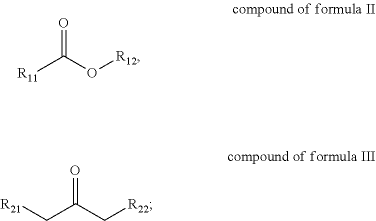
wherein R₁, R₁₂, R₂₁, and R₂₂ are each independently a C₁-C₁₀ alkyl; and
(3) a second compound, wherein the second compound comprises at least one of a compound of formula IV or a compound of formula V: 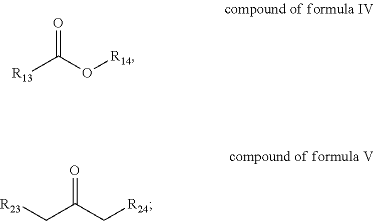
wherein:
R₁₃ and R₁₄ are each independently a substituted or unsubstituted C₁-C₁₀ alkyl, wherein at least one of R₁₃ or R₁₄ is substituted;
R₂₃ and R₂₄ are each independently a substituted or unsubstituted C₁-C₁₀ alkyl, wherein at least one of R₂₃ or R₂₄ is substituted;
when substituted, substituents are each independently a halogen; and
based on a mass of the electrolyte, a mass percentage of the first compound is A %, a mass percentage of the fluorinated cyclic carbonate is B %, and a mass percentage of the second compound is C %, wherein 30≤(A+B+C)≤90 and 20≤C≤61.

16. The electrochemical device according to claim 15, wherein 50≤(A+B+C)≤87.5.

17. The electrochemical device according to claim 15, wherein:
the compound of formula II comprises at least one selected from the group consisting of the following compounds: methyl formate, ethyl formate, methyl acetate, ethyl acetate, propyl acetate, methyl propionate, ethyl propionate, and propyl propionate; and/or
the compound of formula III comprises at least one selected from the group consisting of the following compounds: dimethyl carbonate, diethyl carbonate, and ethyl methyl carbonate.

18. The electrochemical device according to claim 15, wherein the fluorinated cyclic carbonate comprises at least one selected from the group consisting of the following compounds:

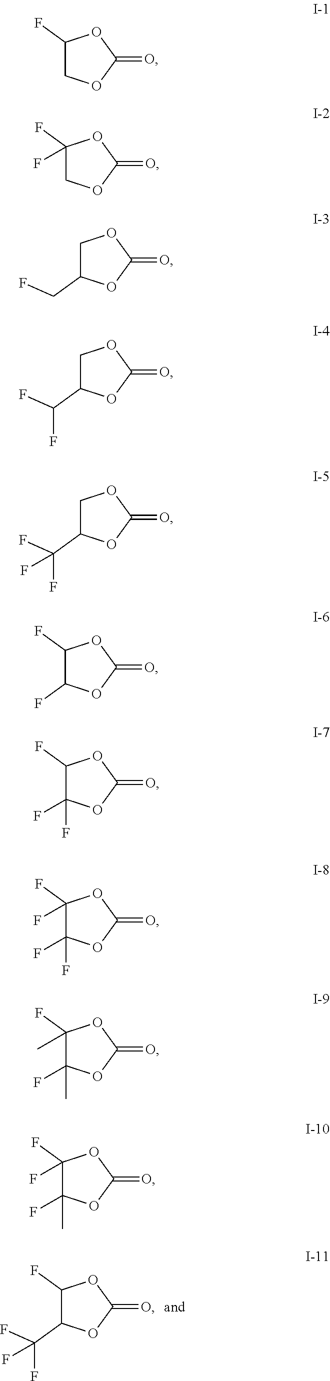

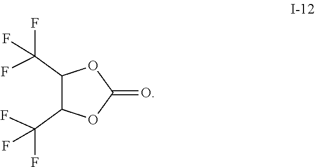 [SMILES: O=C1OC(C(F)(F)F)C(C(F)(F)F)O1]

19. The electrochemical device according to claim 15, wherein the compound of formula IV comprises at least one selected from the group consisting of the following compounds: 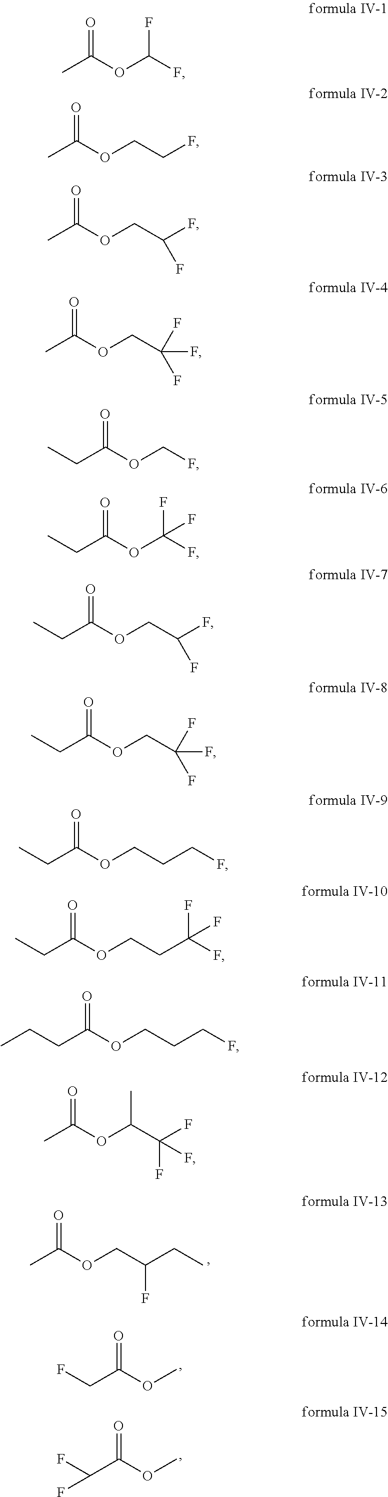 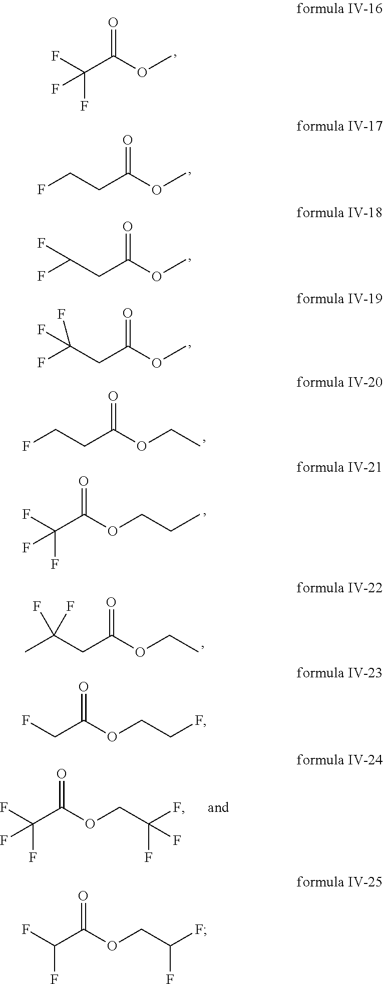
and/or
the compound of formula V comprises at least one selected from the group consisting of the following compounds:

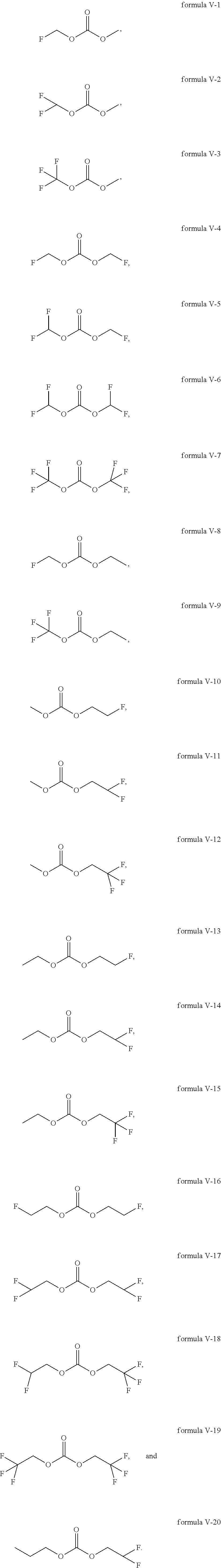

20. An electronic device, comprising an electrochemical device; the electrochemical device comprises a positive electrode, a negative electrode, a separator, and an electrolyte; the electrolyte comprising:
(1) a fluorinated cyclic carbonate represented by formula I: 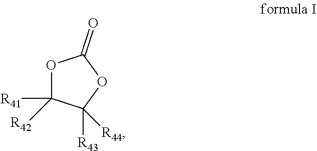
wherein R₄₁, R₄₂, R₄₃, and R₄₄ are each independently F or a substituted or unsubstituted C₁-C₃ alkyl; when substituted, substituents are each independently a halogen; wherein at least one of R₄₁, R₄₂, R₄₃, or R₄₄ contains F;
(2) a first compound, wherein the first compound comprises at least one of a compound of formula II or a compound of formula III: 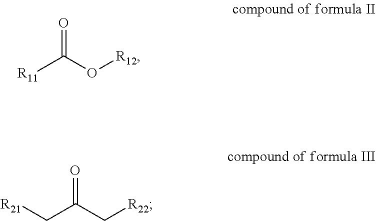
wherein R₁₁, R₁₂, R₂₁, and R₂₂ are each independently a C₁-C₁₀ alkyl; and
(3) a second compound, wherein the second compound comprises at least one of a compound of formula IV or a compound of formula V: 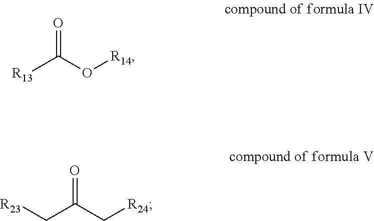
wherein:
R₁₃ and R₁₄ are each independently a substituted or unsubstituted C₁-C₁₀ alkyl, wherein at least one of R₁₃ or R₁₄ is substituted;
R₂₃ and R₂₄ are each independently a substituted or unsubstituted C₁-C₁₀ alkyl, wherein at least one of R₂₃ or R₂₄ is substituted;
when substituted, substituents are each independently a halogen; and
based on a mass of the electrolyte, a mass percentage of the first compound is A %, a mass percentage of the fluorinated cyclic carbonate is B %, and a mass percentage of the second compound is C %, wherein 30≤(A+B+C)≤90 and 20≤C≤61.
